(19) United States
(12) Patent Application Publication
(10) Pub. No.: US 2009/0065676 A1
(43) Pub. Date: Mar. 12, 2009

(54) HIGH TEMPERATURE RUBBER TO METAL BONDED DEVICES AND METHODS OF MAKING HIGH TEMPERATURE ENGINE MOUNTS

(76) Inventors: James R. Halladay, Erie, PA (US); Timothy D. Fornes, Apex, NC (US); Frank J. Krakowski, Erie, PA (US)

Correspondence Address: LORD CORPORATION;PATENT & LEGAL SERVICES, 111 LORD DRIVE, P.O. Box 8012, CARY, NC, 27512-8012, US

(21) Appl. No.: 12/133,718

(22) Filed: Jun. 5, 2008

Related U.S. Application Data
(60) Provisional application No. 60/942,056, filed on Jun. 5, 2007.

(51) Int. Cl. F16M 11/20; F16M 5/00

(52) U.S. Cl. 248/647; 248/637

(57) ABSTRACT

An engine mount for a high temperature operating engine is provided. The high temperature rubber to metal bonded engine mount isolates the vehicle engine from the vehicle body structure in the high temperature operating engine operation environment which has a temperature of at least 190 degrees Fahrenheit. The high temperature engine mount includes a nonelastomeric engine mount member for attachment to the high temperature operating engine and a nonelastomeric body mount member for attachment to the body structure. The high temperature engine mount includes an intermediate elastomer disposed between the nonelastomeric engine mount member and the nonelastomeric body mount member. The high temperature engine mount has an operational lifetime beginning spring rate SR_{B} and an operational lifetime end spring rate SR_{E} with SR_{E}=0.8 SR_{B}, with an operational lifetime OL measured by operational deflection cycles between the nonelastomeric engine mount member and the nonelastomeric body mount member until the operational lifetime end spring rate SR_{E} is reached, wherein the engine mount has an increased operational lifetime OL at the engine operation environment temperature of at least 190 degrees Fahrenheit with the intermediate elastomer including a plurality of dispersed nonelastomeric nanosheets having an aspect ratio of at least 5 to 1.

### CROSS REFERENCE

This application claims the benefit of, and incorporates by reference, U.S. Provisional Patent Application No. 60/942,056 filed on Jun. 5, 2007.

### FIELD OF THE INVENTION

The invention relates to the field of high temperature rubber devices. The invention relates to the field of high temperature engine mounts. More particularly the invention relates to the field of high temperature rubber to metal bonded devices and high temperature rubber to metal bonded engine mounts.

### SUMMARY

In an embodiment the invention includes an engine mount for isolating a high temperature operating engine from a body structure, the high temperature operating engine having an engine operation environment temperature of at least 190 degrees Fahrenheit. The engine mount includes at least a first nonelastomeric engine mount member for attachment to the high temperature operating engine. The engine mount includes at least a second nonelastomeric body mount member for attachment to the body structure. The engine mount includes an intermediate elastomer, the intermediate elastomer disposed between the first nonelastomeric engine mount member and the second nonelastomeric body mount member. The engine mount has an operational lifetime beginning spring rate SR_{B} and an operational lifetime end spring rate SR_{E}, with an operational lifetime OL measured by a plurality of operational deflection cycles between the first nonelastomeric engine mount member and the second nonelastomeric body mount member until the operational lifetime end spring rate SR_{E} is reached, wherein the engine mount has an increased operational lifetime OL at the engine operation environment temperature of at least 190 degrees Fahrenheit with the intermediate elastomer including a plurality of dispersed nonelastomeric nanosheets having an aspect ratio of at least 5 to 1.

In an embodiment the invention includes a method of making an engine mount. The method includes providing a first nonelastomeric engine mount member. The method includes providing a second nonelastomeric body member. The method includes disposing a heat resistant intermediate elastomer between the first nonelastomeric engine mount member and the second body member with the heat resistant intermediate elastomer including dispersed nonelastomeric nanosheets.

In an embodiment the invention includes a method of making a motion control device. The method includes providing a first nonelastomeric motion control device member. The method includes providing a second nonelastomeric motion control device member. The method includes disposing an elastomer between the first nonelastomeric motion control device member and the second nonelastomeric motion control device member wherein the elastomer is cyclically worked by a plurality of cyclic motions between the first nonelastomeric motion control device member and the second nonelastomeric motion control device member with the elastomer including a plurality of nonelastomeric nanosheets dispersed in the elastomer wherein the elastomer maintains an acceptable operational elastomer physical structural integrity level for a plurality of additional cyclic motions when the elastomer is cyclically worked in an operation environmental temperature of at least 190° F.

In an embodiment the invention includes a method of making a motion control device. The method includes providing a first nonelastomeric motion control device member. The method includes providing a second nonelastomeric motion control device member. The method includes disposing an elastomer between the first nonelastomeric motion control device member and the second nonelastomeric motion control device member wherein the elastomer is cyclically worked by a plurality of cyclic motions between the first nonelastomeric motion control device member and the second nonelastomeric motion control device member with the elastomer including a plurality of nonelastomeric nanosheets dispersed in the elastomer wherein the elastomer maintains an acceptable operational spring rate level for a plurality of additional cyclic motions when the elastomer is cyclically worked in an operation environmental temperature of at least 190° F.

In an embodiment the invention includes a method of making a machine component. The method includes providing a first nonelastomeric machine component member. The method includes bonding a >190° F. heat spring rate fatigue resistant elastomer to the first nonelastomeric machine component member with the >190° F. heat spring rate fatigue resistant elastomer including a plurality of dispersed nonelastomeric nanosheets to provide an at least 190° F. heat resistant machine component.

In an embodiment the invention includes a method of making a vehicle. The method includes providing a vehicle having an operational environment temperature of at least 190 degrees Fahrenheit. The method includes providing a machine component, the machine component including an elastomer having a plurality of dispersed nonelastomeric nanosheets. The method includes installing the machine component in the vehicle wherein the elastomer is heated to at least 190 degrees Fahrenheit in the operational environment temperature of at least 190 degrees Fahrenheit.

In an embodiment the invention includes a machine component. The machine component includes an intermediate elastomeric body, the intermediate elastomeric body providing an acceptable machine component spring rate performance operational lifetime. The intermediate elastomeric body is comprised of an elastomer having an elastomer composition, the elastomer including a plurality of dispersed nonelastomeric nanosheets, the dispersed nonelastomeric nanosheets having a first planar dimension greater than 25 nm, a second planar dimension greater than 25 nm, and a thickness dimension less than 2 nm, wherein the intermediate elastomeric body has an increased acceptable machine component spring rate performance operational lifetime above 190° F. relative to the elastomer composition absent the dispersed nonelastomeric nanosheets.

In an embodiment the invention includes a machine component. The machine component includes an intermediate elastomeric body, the intermediate elastomeric body providing an acceptable machine component spring rate performance operational lifetime, the intermediate elastomeric body comprised of a elastomer having an elastomer composition, the elastomer including a means for increasing the acceptable machine component spring rate performance operational lifetime in an above 190° F. operation temperature environment.

In an embodiment the invention includes a machine component. The machine component includes an intermediate elastomeric body, the intermediate elastomeric body providing an acceptable machine component elastomer structural integrity operational lifetime, the intermediate elastomeric body comprised of a elastomer having an elastomer composition, the elastomer including a plurality of dispersed nonelastomeric nanosheets, the dispersed nonelastomeric nanosheets having a first planar dimension greater than 25 nm, a second planar dimension greater than 25 nm, and a thickness dimension less than 2 nm, wherein the intermediate elastomeric body has an increased acceptable machine component operational lifetime above 190° F. relative to the elastomer composition absent the dispersed nonelastomeric nanosheets.

In an embodiment the invention includes a machine component. The machine component includes an intermediate elastomeric body, the intermediate elastomeric body providing an acceptable machine component elastomer structural integrity operational lifetime, the intermediate elastomeric body comprised of a elastomer having an elastomer composition, the elastomer including a means for increasing the acceptable machine component operational lifetime in an above 190° F. operation temperature environment.

In an embodiment the invention includes an engine mount. The engine mount includes an at least a first nonelastomeric engine mount member and an at least a second nonelastomeric mount member, and an intermediate elastomeric body bonded between the first nonelastomeric engine mount member and the second nonelastomeric mount member. The intermediate elastomeric body is comprised of a >210° F. heat resistant elastomer having a plurality of dispersed nonelastomeric nanosheets with a first planar dimension greater than 25 nm, a second planar dimension greater than 25 nm, and a thickness dimension less than 2 nm.

In an embodiment the invention includes a rubber to metal device for connecting a high temperature operating heat source to a body structure, the high temperature operating heat source having a heat source operation environment temperature of at least 190 degrees Fahrenheit. The rubber to metal device includes at least a first metal member for attachment to the high temperature operating heat source. The rubber to metal device includes at least a second metal member for attachment to the body structure. The rubber to metal device includes an intermediate rubber, the intermediate rubber disposed between the first metal member and the second metal member. The rubber to metal device has an operational lifetime beginning spring rate SR_{B} and an operational lifetime end spring rate SR_{E} with SR_{E}=0.8 SR_{B}, with an operational lifetime OL measured by a plurality of operational deflection cycles between the first metal member and the second metal member until the operational lifetime end spring rate SR_{E} is reached, wherein the rubber to metal device has an increased operational lifetime OL at the heat source operation environment temperature of at least 190 degrees Fahrenheit with the intermediate rubber including a plurality of dispersed nonelastomeric nanosheets having an aspect ratio of at least 5 to 1.

In an embodiment the invention includes a method of making a rubber to metal device. The method includes providing a first metal member. The method includes providing a second nonelastomeric body member. The method includes disposing a heat resistant intermediate rubber between the first metal member and the second body member with the heat resistant intermediate rubber including a plurality of dispersed nonelastomeric nanosheets.

In an embodiment the invention includes providing a masterbatch comprising an organoclay dispersed in a compatibilizer. The compatibilizer preferably comprises an olefinic compound having a slight polarity. The clay preferably comprises an organosilicate, a 2:1 multi-layered swellable silicate clay having a cationically exchangeable ion in its galleries.

In an embodiment the invention includes providing a masterbatch. Preferably providing the masterbatch includes intercalating and at least partially exfoliating a clay in a compatibilizer to produce an at least partially exfoliated and dispersed clay masterbatch. By mixing the clay with a compatibilizer, the compatibilizer intercalates the galleries thereby swelling them slightly and allowing the shear forces created by mechanical mixing to break apart the galleries and at least partially exfoliate the clay. Once at least partially exfoliated, the individual clay platelets or small “stacks” of platelets can disperse throughout the compatibilizer. Continued shear force through mixing will further separate the galleries and better exfoliate the clay.

In an embodiment of the invention the dispersed clay masterbatch is mixed with a non-polar elastomer to disperse the clay within the elastomer matrix and create an elastomer nanocomposite. Preferably the compatibilizer provides for the pre-dispersed clay to disperse freely in the elastomer matrix. In this manner an elastomer nanocomposite comprising a clay substantially exfoliated and dispersed in an elastomer is provided.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1A shows a high temperature rubber to metal bonded engine mount component device for isolating and controlling the motion of a machine engine.

FIG. 1B illustrates a cross-section of the high temperature rubber to metal bonded fluid containing engine mount shown in FIG. 1A with an intermediate elastomer with dispersed nonelastomeric nanosheets.

FIG. 2A shows a high temperature rubber to metal bonded engine mount component device for isolating and controlling the motion of a machine engine.

FIG. 2B illustrates a cross-section of the high temperature rubber to metal bonded fluid free engine mount shown in FIG. 2A with an intermediate elastomer with dispersed nonelastomeric nanosheets.

FIG. 2C illustrates a cross-section of the high temperature rubber to metal bonded fluid free engine mount shown in FIG. 2A with an intermediate elastomer with dispersed nonelastomeric nanosheets.

FIG. 2D illustrates a cross-section of the high temperature rubber to metal bonded fluid free engine mount shown in FIG. 2A with an intermediate elastomer with dispersed nonelastomeric nanosheets.

FIG. 2E illustrates a cross-section of the high temperature rubber to metal bonded fluid free engine mount shown in FIG. 2A with an intermediate elastomer with dispersed nonelastomeric nanosheets.

FIG. 2F illustrates a view of the high temperature rubber to metal bonded engine mount component device shown in FIG. 2A.

FIG. 2G illustrates a cross-section of the high temperature rubber to metal bonded fluid free engine mount shown in FIG. 2F with an intermediate elastomer with dispersed nonelastomeric nanosheets.

FIG. 3 shows a high temperature operating mount with a first centered inner nonelastomeric mount member and a pair of outer second nonelastomeric body mount members with an intermediate elastomer with dispersed nonelastomeric nanosheets in between.

FIG. 4A is photomicrograph of an elastomer with the dispersed nanosheets from a clay nanosheet masterbatch, with the TEM low magnification photograph showing the nanosheets dispersed in the elastomer.

FIG. 4B is an enlargement photomicrograph of the elastomer of FIG. 4A with the dispersed nanosheets from a clay nanosheet masterbatch, with the TEM high magnification photograph showing the nanosheets dispersed in the elastomer from the dashed box area of FIG. 4A.

FIG. 4C is a photograph of a rubber substrate with organically modified clay particles mixed therein, the clay and rubber were not subjected to the masterbatch process according to the invention and as shown in the photograph, the clay particles are not exfoliated and visibly aggregated together in clumps.

FIG. 5 illustrates the high temperature operational lifetime of the FL engine mounts shown in FIG. 1A-B with the intermediate elastomer with the dispersed nanosheets.

FIG. 6 illustrates the high temperature operational lifetime of the TF engine mounts shown in FIG. 2A-G with the intermediate elastomer with the dispersed nanosheets.

FIG. 7 illustrates the high temperature operational lifetime of the TL mount shown in FIG. 3 with the intermediate elastomer with the dispersed nanosheets.

FIG. 8A illustrates the high temperature operational lifetime engine machine component mounts isolating the internal combustion high temperature engine in an above 190° F. operation temperature environment of a wheeled land truck machine vehicle.

FIG. 8B illustrates the high temperature operational lifetime engine machine component mounts isolating the internal combustion high temperature engine in an above 190° F. operation temperature environment of a boat machine marine vehicle.

FIG. 8C illustrates the high temperature operational lifetime engine machine component mounts of FIG. 1A-B isolating the internal combustion high temperature engine in an above 190° F. operation temperature environment from the vehicle structure frame of a machine.

FIG. 8D illustrates the high temperature operational lifetime engine machine component mounts of FIG. 2A-G isolating the internal combustion high temperature engine in an above 190° F. operation temperature environment from the vehicle structure frame of a machine.

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes an engine mount for isolating a high temperature operating engine from a body structure, the high temperature operating engine having an engine operation environment temperature of at least 190 degrees Fahrenheit. The engine mount includes at least a first nonelastomeric engine mount member for attachment to the high temperature operating engine. The engine mount includes at least a second nonelastomeric body mount member for attachment to the body structure. The engine mount includes an intermediate elastomer, the intermediate elastomer disposed between the first nonelastomeric engine mount member and the second nonelastomeric body mount member. The engine mount has an operational lifetime beginning spring rate SR_{B} and an operational lifetime end spring rate SR_{E}, with an operational lifetime OL measured by a plurality of operational deflection cycles between the first nonelastomeric engine mount member and the second nonelastomeric body mount member until the operational lifetime end spring rate SR_{E} is reached, wherein the engine mount has an increased operational lifetime OL at the engine operation environment temperature of at least 190 degrees Fahrenheit with the intermediate elastomer including a plurality of dispersed nonelastomeric nanosheets having an aspect ratio of at least 5 to 1.

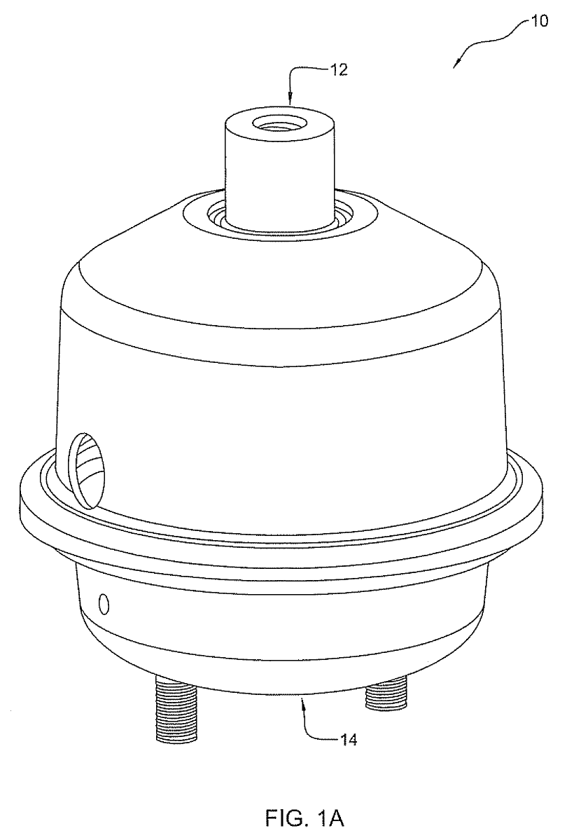

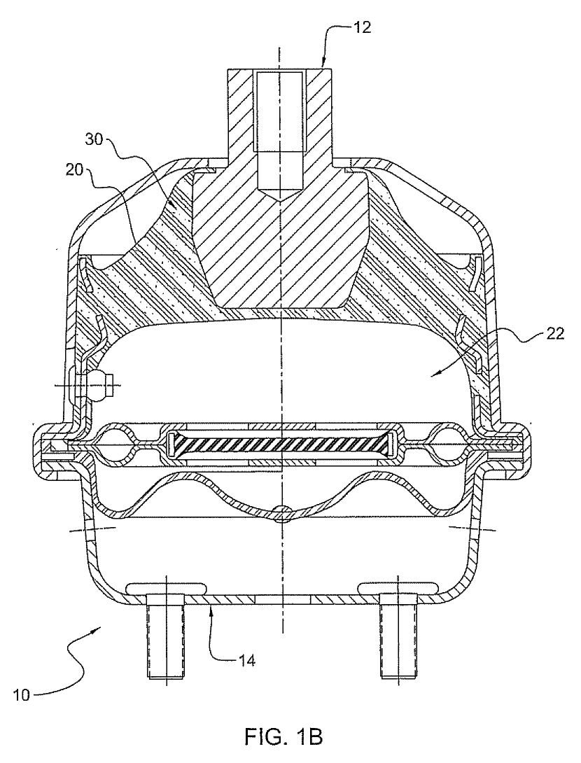

In an embodiment the engine mount 10 is a device for isolating a high temperature operating engine from a body structure, the high temperature operating engine having an engine operation environment temperature of at least 190 degrees Fahrenheit. The engine mount includes at least a first nonelastomeric engine mount member 12 for attachment to the high temperature operating engine 100. The engine mount includes at least a second nonelastomeric body mount member 14 for attachment to the body structure 200. The engine mount includes an intermediate elastomer 20, the intermediate elastomer disposed between the first nonelastomeric engine mount member and the second nonelastomeric body mount member. The engine mount has an operational lifetime beginning spring rate SR_{B} and an operational lifetime end spring rate SR_{E} with SR_{E}=0.8 SR_{B}, with an operational lifetime OL measured by the operational deflection cycles between the first nonelastomeric engine mount member 12 and the second nonelastomeric body mount member 14 until the operational lifetime end spring rate SR_{E} is reached, wherein the engine mount 10 has an increased operational lifetime OL at the engine operation environment temperature of at least 190 degrees Fahrenheit with the intermediate elastomer 20 including dispersed nonelastomeric nanosheets 30 having a sheet aspect ratio of at least 5 to 1. FIG. 1 (FL elastomer mount) shows a high temperature >190° F. operating engine mount 10 with first nonelastomeric engine mount member 12 and second nonelastomeric body mount member 14 with intermediate elastomer 20. In a preferred embodiment the high temperature >190° F. operating engine mount 10 contains a mount fluid 22.

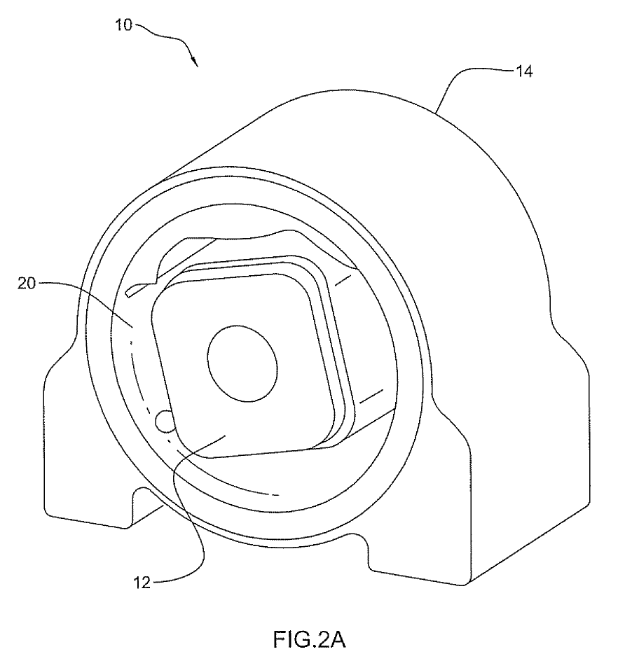

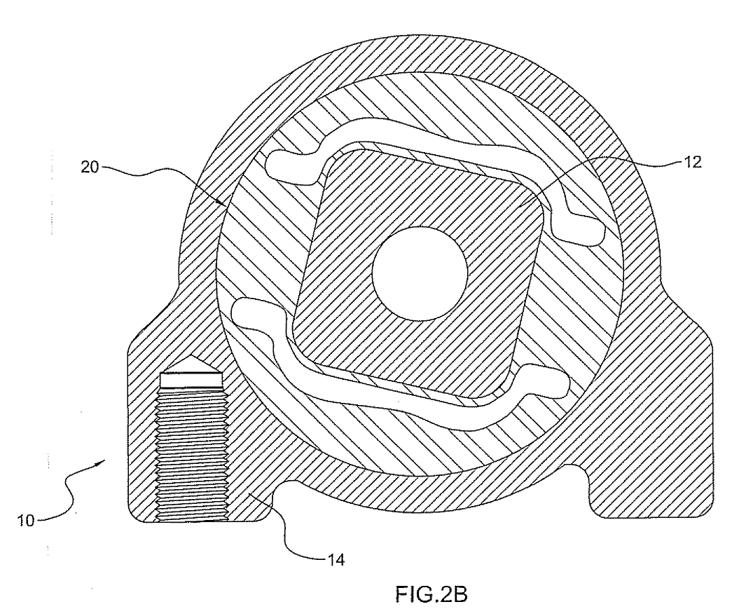

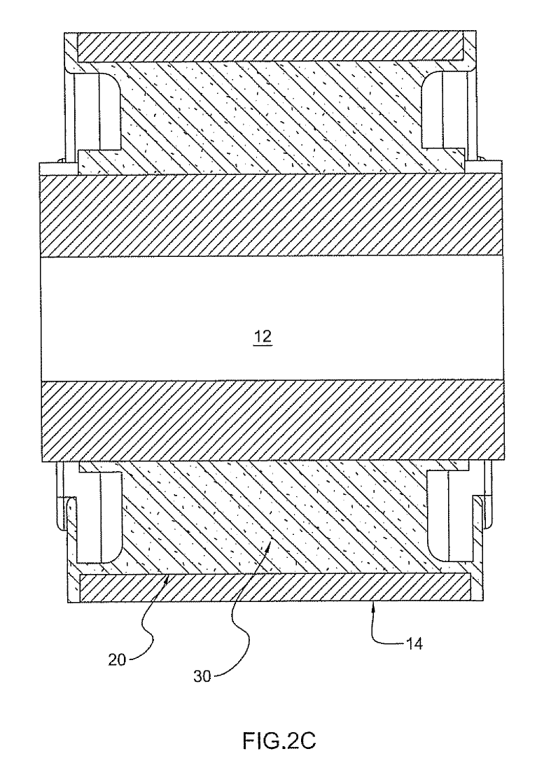

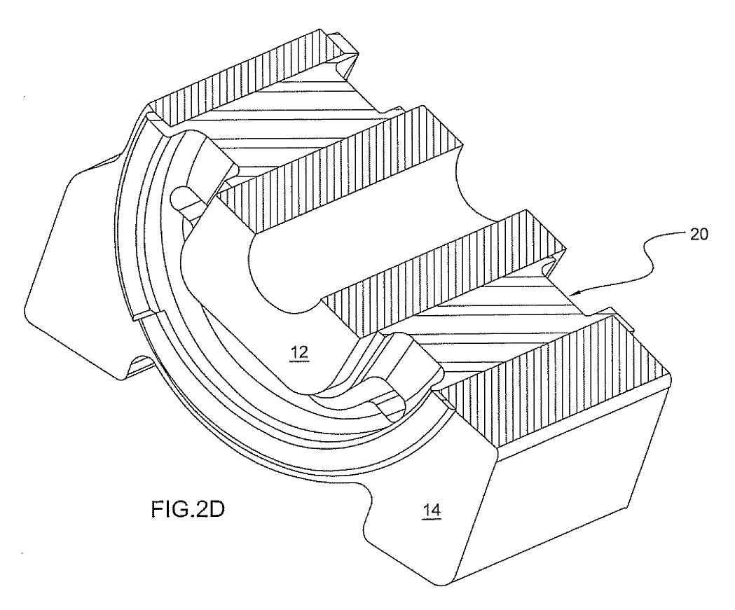

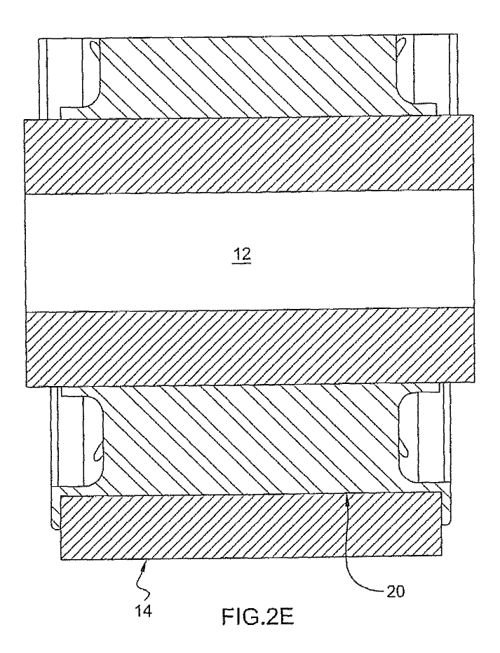

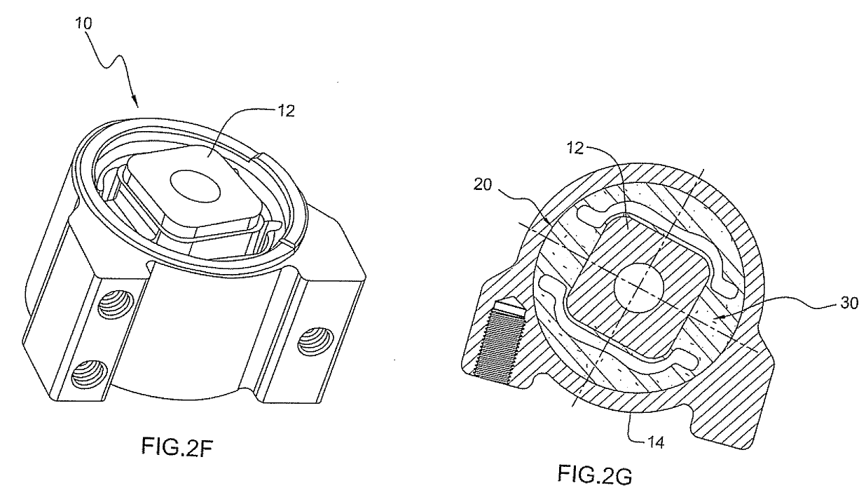

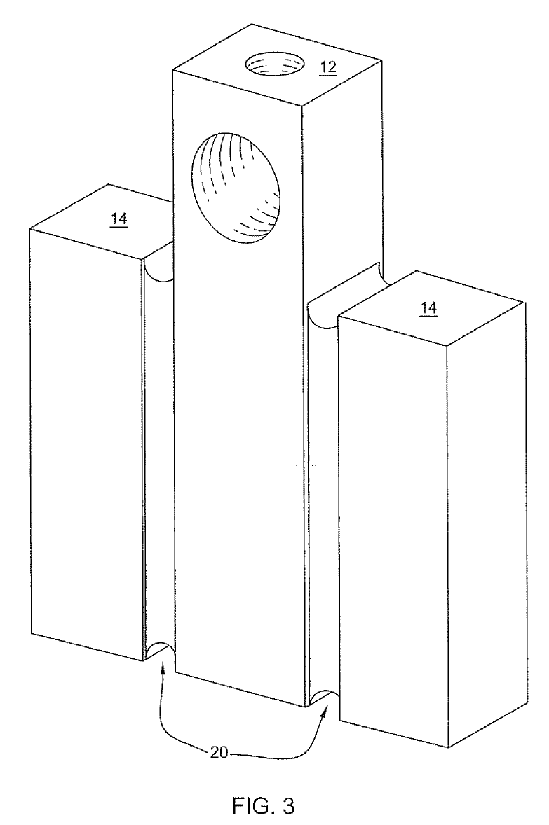

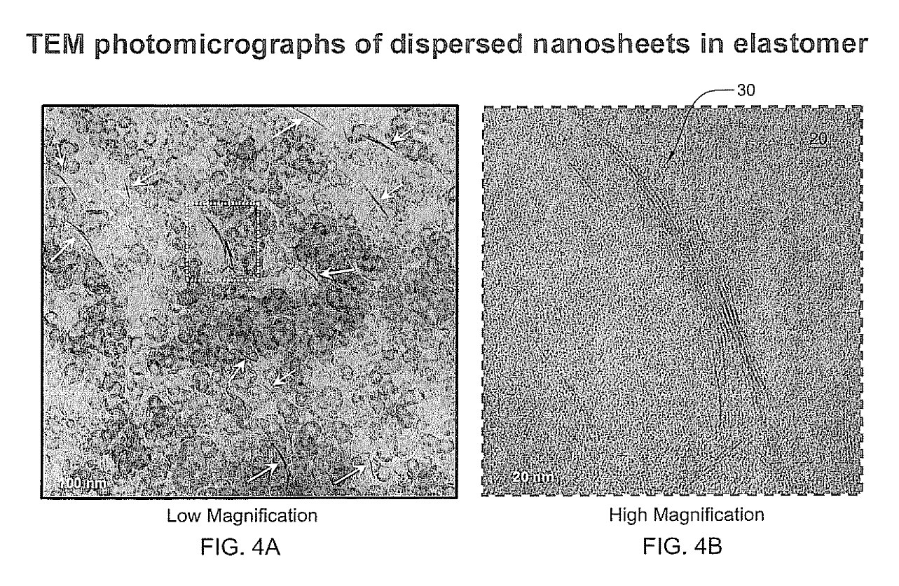

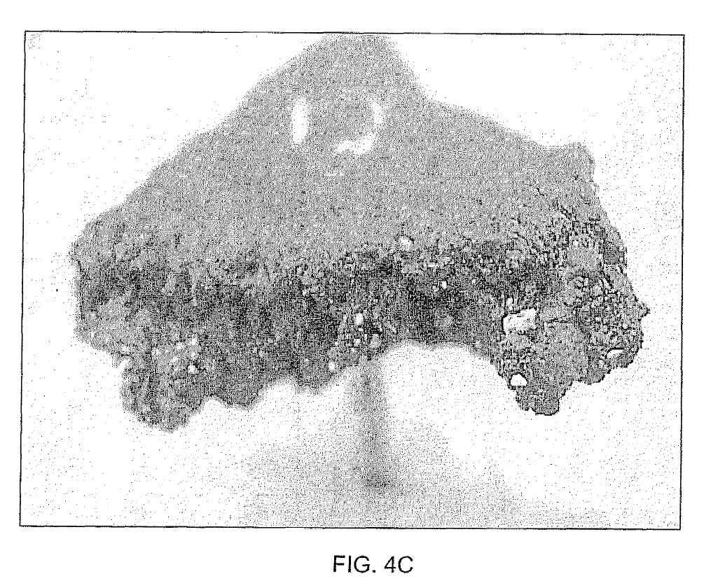

FIG. 2 shows a high temperature >190° F. operating engine mount 10 with first nonelastomeric engine mount member 12 and second nonelastomeric body mount member 14 with intermediate elastomer 20. In a preferred embodiment the high temperature >190° F. operating engine mount 10 is fluid free. FIG. 3 shows a high temperature >190° F. operating mount 10 with first nonelastomeric mount member 12 and second nonelastomeric body mount member 14 with intermediate elastomer 20. FIG. 4 are TEM photomicrographs of elastomer 20 with dispersed nonelastomeric nanosheets 30 (pointed at with white arrows in low magnification FIG. 4A). Mounts 10 as shown in FIG. 1-3 were made with intermediate elastomer 20 including dispersed nonelastomeric nanosheets 30 having a sheet aspect ratio of at least 5 to 1. Preferably nanosheets 30 have an aspect ratio of at least 5 to 1 for a single nanosheet either in a stack or alone surrounded by elastomer 20. Preferably nanosheets 30 have at least a first planar dimension greater than 25 nm and at least one dimension less than 25 nm, preferably with a second planar dimension greater than 25 nm, and the at least one dimension less than 25 nm is the nanosheet thickness. Preferably the nanosheet thickness is preferably less than 2 nm, preferably with the nanosheet thickness centered about 1 nm (1±0.1 nm) with first and second normal planar direction dimensions greater than 25 nm. For a single nanosheets (multiple adjacent single nanosheets can make a stack of preferably 2 to 10, preferably stacks have no more than 20 adjacent nanosheets) the single nanosheet preferably has the aspect ratio of the planar length width dimension to the thickness dimension of at least 5 to 1, preferably at least 10 to 1, preferably at least 15 to 1, preferably at least 20 to 1, and most preferably at least 25 to 1 (at least 25 nm length or width planar dimension to 1 nm thickness dimension). For multiple adjacent single nanosheets in a stack, preferably the stack has no more than 20 adjacent nanosheets, and preferably the stack is comprised of 2 to 10 nanosheets.

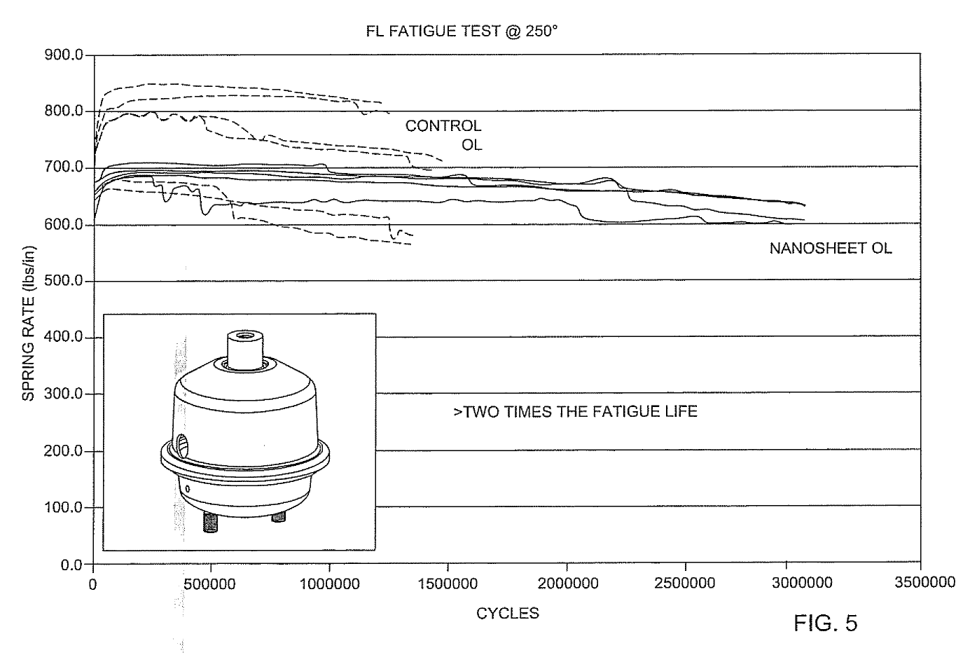

FIG. 1 FL elastomer mounts were made with intermediate elastomer 20 including dispersed nonelastomeric nanosheets 30 along with control mounts made with the elastomer absent the nanosheets 30. The FL elastomer mounts were tested in a heated laboratory test bed enclosure environment at 250° F. with mount testing displacements cycling at 4 Hz displacement frequency (0.5 inch displacements). In FIG. 5 the control mounts absent the nanosheets 30 are shown with dashed plot lines as compared with the nanosheet containing elastomer 20 shown with solid plot lines. The ends of the plot lines indicate the OL operational lifetime where the mount testing was terminated when the mount's elastomer failed to maintain an acceptable operational elastomer physical structural integrity level, with the elastomer in these FL mounts failure detected by the onset of mount fluid 22 leaking from the mount.

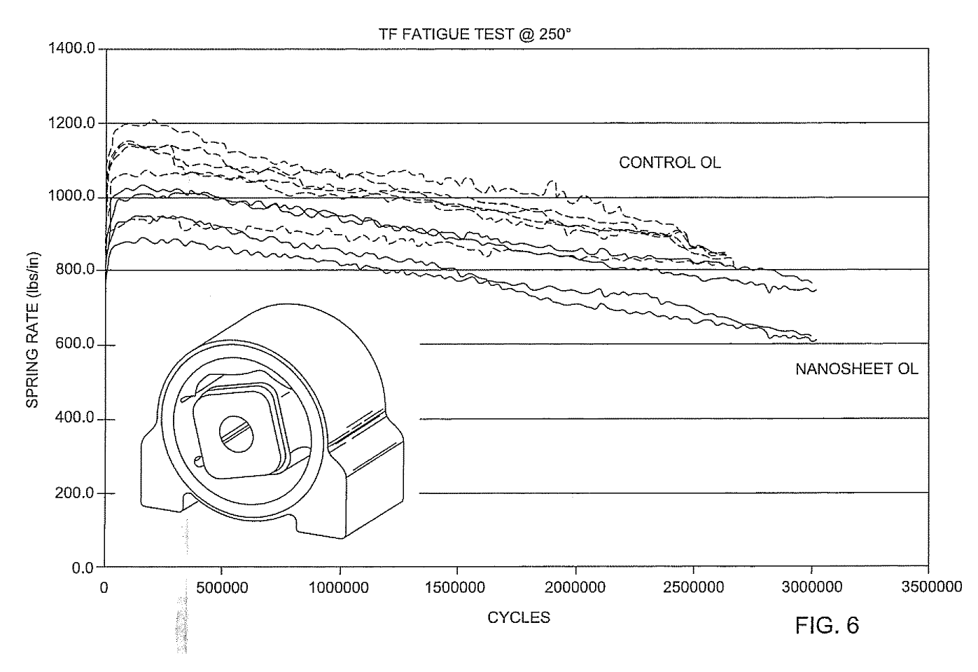

FIG. 2 TF elastomer mounts were made with intermediate elastomer 20 including dispersed nonelastomeric nanosheets 30 along with control mounts made with the elastomer absent the nanosheets 30. The TF elastomer mounts were tested in a heated laboratory test bed enclosure environment at 250° F. with mount testing displacements cycling at 2 Hz displacement frequency with displacements of plus/minus 0.125 inch. In FIG. 6 the control mounts absent the nanosheets 30 are shown with dashed plot lines as compared with the nanosheet containing elastomer 20 shown with solid plot lines. The ends of the plot lines indicate the OL operational lifetime where the mount's operational lifetime end spring rate SR_{E} reached 80% of the with beginning spring rate (SR_{E}=0.8 SR_{B}).

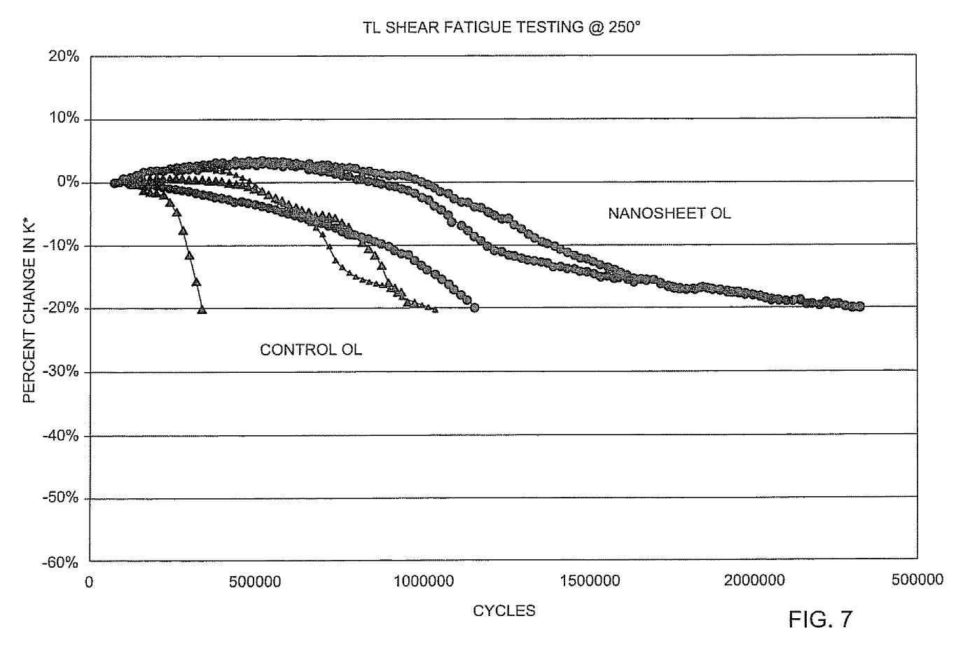

FIG. 3 TL elastomer mounts were made with intermediate elastomer 20 including dispersed nonelastomeric nanosheets 30 along with control mounts made with the elastomer absent the nanosheets 30. The TL elastomer mounts were tested in a heated laboratory test bed enclosure environment at 250° F. with mount testing displacements cycling at 10 Hz with a static displacement of +0.069″ and a dynamic of ±0.059″. In FIG. 7 the control mounts absent the nanosheets 30 are shown with dashed plot lines with triangles as compared with the nanosheet containing elastomer 20 shown with solid plot lines with circles. The ends of the plot lines indicate the OL operational lifetime where the mount's operational lifetime end spring rate SR_{E} reached 80% of the with beginning spring rate (SR_{E}=0.8 SR_{B}).

FIG. 4C illustrates a cross sectional view of a rubber substrate with organically modified clay particles mixed therein. The clay and rubber were not subjected to the masterbatch process according to the preferred embodiments of the invention and as can be seen in the photograph, the clay particles are not exfoliated and visibly aggregated together in clumps.

FIG. 4B is a photograph taken with a scanning electron microscope illustrating a section of rubber having well dispersed clay particles therein. The clay particles are identified by the arrows and can be seen in small clusters of platelets throughout the rubber matrix. These platelets have undergone the masterbatch exfoliation process of the present invention to achieve the high level of exfoliation and dispersion shown here. The larger black spherical particles are carbon black which has been added to the rubber as is known in the art. FIG. 4B is an enlargement of the section defined by dotted lines in FIG. 4A. In this section the individual clay platelets are visible in stacks of about 1 to about 15 platelets.

Preferably the high temperature >190° F. operating mount with nanosheet containing elastomer has the increased operational lifetime OL of at least ten percent greater than the operational lifetime of the second comparison engine mounts with the intermediate elastomer absent the dispersed nonelastomeric nanosheets. Preferably the engine mount has the increased operational lifetime OL with the engine operation environment temperature at least 196 degrees Fahrenheit, preferably at least 202 degrees Fahrenheit, preferably at least 208 degrees Fahrenheit, preferably at least 214 degrees Fahrenheit, preferably at least 220 degrees Fahrenheit, preferably at least 226 degrees Fahrenheit, preferably at least 232 degrees Fahrenheit, preferably at least 214 degrees Fahrenheit, preferably at least 238 degrees Fahrenheit, preferably at least 244 degrees Fahrenheit, and preferably at least 249 degrees Fahrenheit, and most preferably about 250 (250±10) degrees Fahrenheit.

Preferably the elastomer 20 includes a predetermined effective weight percentage amount of the dispersed nonelastomeric nanosheets 30 to provide the engine mount 10 with a substantial increase in the operational lifetime OL. Preferably the effective weight percentage range of nanosheets (nonorganic nonelastomer sheet mineral weight) is in the range of 0.5 to 10 weight %, more preferably in the range of about 1 to 5 weight % in the elastomer composition. Preferably the increased operational lifetime OL is at least fifteen percent greater than the operational lifetime of the second comparison engine mount with the intermediate elastomer absent the dispersed nonelastomeric nanosheets 30. Preferably the increased operational lifetime OL is at least twenty five percent greater than the operational lifetime of the second comparison engine mount with the intermediate elastomer absent the dispersed nonelastomeric nanosheets 30. Preferably the increased operational lifetime OL is at least fifty percent greater than an operational lifetime of the second comparison engine mount with the intermediate elastomer absent the dispersed nonelastomeric nanosheets 30. Preferably the increased operational lifetime OL is at least seventy five percent greater than the operational lifetime of the second comparison engine mount with the intermediate elastomer absent the dispersed nonelastomeric nanosheets 30. Preferably the increased operational lifetime OL is at least twice an operational lifetime of the second comparison engine mount with the intermediate elastomer absent the dispersed nonelastomeric nanosheets 30. Preferably the operational deflection cycles compress the intermediate elastomer 20. Preferably the operational deflection cycles shear the intermediate elastomer 20. Preferably the operational deflection cycles compress and shear the intermediate elastomer 20, preferably with the mount elastomer experiencing shear and/or compression loading during operation, and preferably tension loading of the elastomer is inhibited, preferably with avoiding cycled tensioning of elastomer 20. Preferably the engine mount has a spring rate growth peak during the operational lifetime, with the spring rate growth peak at least one percent above the beginning spring rate SR_{B}, preferably at least five percent above the beginning spring rate SR_{B}. Preferably the engine mount contains a fluid 22. Preferably the increased operational lifetime OL is at least one and half million cycles, preferably at least one and three quarter million cycles, preferably at least two million cycles, preferably at least two and half million cycles, preferably at least three million cycles. Preferably the high temperature operating engine 100 is an internal combustion engine. Preferably the body structure 200 is a vehicle body structure. Preferably the dispersed nonelastomeric nanosheets 30 have at least a first dimension greater than 25 nm and at least one thickness dimension less than 25 nm. Preferably the dispersed nonelastomeric nanosheets 30 have a first planar dimension greater than 25 nm, a second planar dimension greater than 25 nm, and a thickness dimension less than 25 nm. Preferably the dispersed nonelastomeric nanosheets 30 are comprised of silicon, preferably a silicate, preferably silicate mineral nanosheets. Preferably the dispersed nonelastomeric nanosheets are comprised of aluminum, preferably aluminum silicate, preferably aluminum silicate mineral nanosheets.

In an embodiment the invention includes a method of making an engine mount. The method includes providing a first nonelastomeric engine mount member. The method includes providing a second nonelastomeric body member. The method includes disposing a heat resistant intermediate elastomer between the first nonelastomeric engine mount member and the second body member with the heat resistant intermediate elastomer including dispersed nonelastomeric nanosheets.

In an embodiment the method of making engine mount 10 includes providing a first nonelastomeric engine mount member 12. The method includes providing a second nonelastomeric body member 14. The method includes disposing a high heat spring rate fatigue resistant intermediate elastomer 20 between the first nonelastomeric engine mount member and the second body member with the heat resistant intermediate elastomer 20 including dispersed nonelastomeric nanosheets 30. Preferably the nanosheets have a sheet aspect ratio of at least 5 to 1, preferably with first planar dimension greater than 25 nm and at least one dimension less than 25 nm, preferably with a second planar dimension greater than 25 nm, and the at least one dimension less than 25 nm is preferably the nanosheet thickness. Preferably the nanosheet thickness is preferably less than 2 nm, preferably centered about 1 nm (1±0.1 nm). Preferably the engine mount 10 has an operational deflection between the first nonelastomeric engine mount member and the second body member which compresses the heat resistant intermediate elastomer 20 with nanosheets 30, preferably with tensile loading and stressing of the elastomer 20 inhibited and avoided with the engine mount disposition of elastomer 20 between nonelastomer rigid members 12 and 14, with the elastomer 20 preferably utilized in compression and/or shear. Preferably the operational deflection between the first nonelastomeric engine mount member 12 and the second body member 14 shears the heat resistant intermediate elastomer, with tensile loading and stressing of the elastomer inhibited and avoided with engine mount disposition of the elastomer between nonelastomer rigid members 12 and 14, with the elastomer preferably utilized in compression and/or shear. Preferably the operational deflection between the first nonelastomeric engine mount member and the second body member compresses and shears the heat resistant intermediate elastomer, with tensile loading and stressing of elastomer inhibited and avoided with the engine mount disposition of elastomer 20 between nonelastomer rigid members, with elastomer 20 preferably utilized in compression and/or shear. Preferably the heat resistant intermediate elastomer 20 is comprised of an elastomeric composition with the nonelastomeric nanosheets 30 dispersed within the elastomeric composition. Preferably the method includes mixing a nanosheet masterbatch with the elastomeric composition, preferably with a predetermined effective weight percentage amount of the dispersed nonelastomeric nanosheets 30 to provide the engine mount 10 with a substantial increase in the operational lifetime OL, preferably with an effective weight percentage range of nanosheets (nonorganic nonelastomer sheet mineral weight percentage), with the effective weight percentage range of nanosheets in the range of 0.5 to 10 weight %, more preferably in the 1 to 5 weight % region in the elastomer composition. Preferably the intermediate elastomer provides an operational lifetime beginning spring rate SR_{B} and an operational lifetime end spring rate SR_{E} with SR_{E}=0.8 SR_{B}, with an operational lifetime OL measured by the operational deflection cycles between the first nonelastomeric member and the second nonelastomeric member until the operational lifetime end spring rate SR_{E} is reached, wherein the engine mount has an increased operational lifetime OL at an engine operation environment temperature of at least 190 degrees Fahrenheit. Preferably the increased operational lifetime OL is at least ten percent greater than an operational lifetime of a second comparison engine mount with the intermediate elastomer absent the plurality of dispersed nonelastomeric nanosheets, preferably the increased operational lifetime OL is at least one and half million cycles. Preferably the intermediate elastomer 20 provides an operational lifetime OL measured by a plurality of operational deflection cycles between a first deflection cycle and a elastomer mount failure lifetime end cycle with the operational deflection cycles between the first nonelastomeric member and the second nonelastomeric member, wherein the engine mount has an increased operational lifetime OL at an engine operation environment temperature of at least 190 degrees Fahrenheit, preferably with the failure end cycle comprising physical structural failure of engine mount, with the elastomer breaking, tearing and/or cracking failure, and with a fluid containing mount the failure end cycle occurs upon having a fluid leak from the failure of the elastomer to contain the fluid in the mount. Preferably the increased operational lifetime OL is at least ten percent greater than an operational lifetime of a second comparison engine mount with the intermediate elastomer 20 absent the plurality of dispersed nonelastomeric nanosheets 30. Preferably the increased operational lifetime OL is at least one and half million cycles. Preferably the intermediate elastomer 20 provides an increased operational lifetime OL at least ten percent greater than an operational lifetime of a second comparison engine mount made with the intermediate elastomer absent the plurality of dispersed nonelastomeric nanosheets 30. Preferably the engine mount has the increased operational lifetime OL with an engine operation environment temperature at least 196 degrees Fahrenheit, preferably at least 208 degrees Fahrenheit, preferably at least 214 degrees Fahrenheit, preferably at least 220 degrees Fahrenheit, preferably at least 226 degrees Fahrenheit, preferably at least 232 degrees Fahrenheit, preferably at least 214 degrees Fahrenheit, preferably at least 238 degrees Fahrenheit, preferably at least 244 degrees Fahrenheit, and preferably at least 250 degrees Fahrenheit, and most preferably the high temperature is centered about 250 (250±10) degrees Fahrenheit.

Preferably the engine mount has the increased operational lifetime OL at least fifteen percent greater than the operational lifetime of the second comparison engine mount with the intermediate elastomer absent the plurality of dispersed nonelastomeric nanosheets 30, preferably with the increased operational lifetime OL at least twenty five percent greater than the operational lifetime of the second comparison engine mount with the intermediate elastomer absent the plurality of dispersed nonelastomeric nanosheets, preferably at least fifty percent greater than the operational lifetime of the second comparison engine mount without the dispersed nonelastomeric nanosheets, preferably at least seventy five percent greater, preferably the engine mount increased operational lifetime OL is at least at least twice the operational lifetime of the second comparison engine mount with the intermediate elastomer absent the plurality of dispersed nonelastomeric nanosheets. Preferably the method includes providing a mount fluid 22 and containing the mount fluid 22 in the engine mount 10 with the intermediate elastomer 20. Preferably the dispersed nonelastomeric nanosheets 30 have at least a first dimension greater than 25 nm and at least one thickness dimension less than 25 nm. Preferably the dispersed nonelastomeric nanosheets 30 have a first planar dimension greater than 25 nm, a second planar dimension greater than 25 nm, and a thickness dimension less than 25 nm. Preferably the dispersed nonelastomeric nanosheets 30 are comprised of silicon, preferably a silicate, preferably silicate mineral nanosheets. Preferably the dispersed nonelastomeric nanosheets are comprised of aluminum, preferably aluminum silicate, preferably aluminum silicate mineral nanosheets.

Preferably the first nonelastomeric engine mount member 12 is provided for connection proximate a high temperature operating internal combustion engine 100. Preferably the second nonelastomeric body member 14 is provided for connection proximate a vehicle body structure 200.

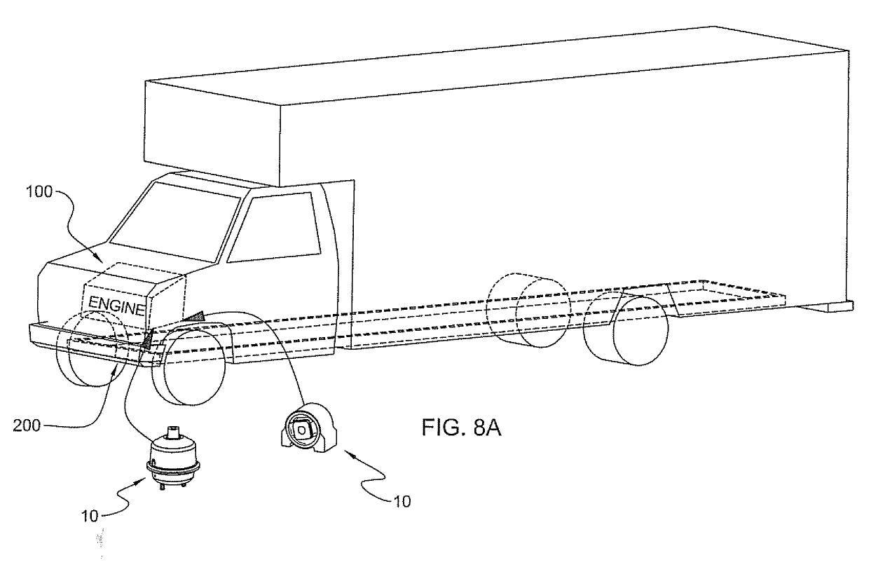

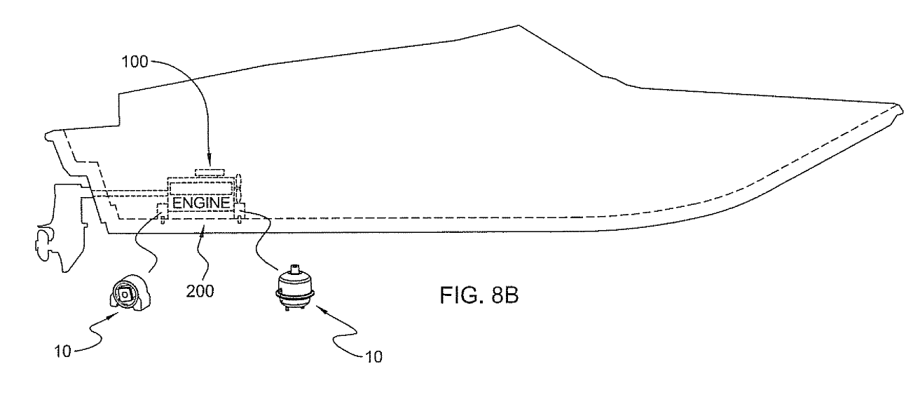

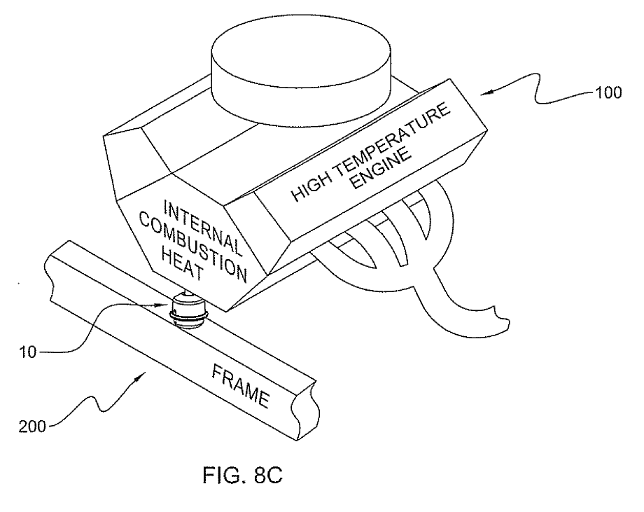

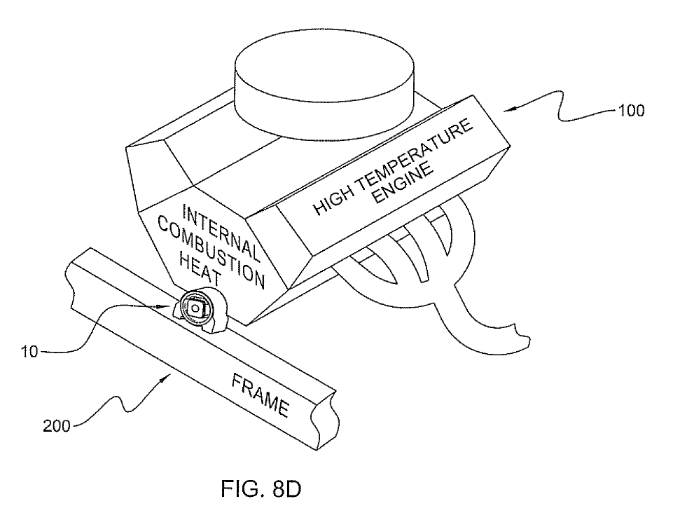

Preferably the mounts are made with the intermediate elastomer 20 including dispersed nonelastomeric nanosheets 30 having a sheet aspect ratio of at least 5 to 1. FIG. 1 (FL elastomer mount) shows a high temperature >190° F. operating engine mount 10 made with first nonelastomeric engine mount member 12 and second nonelastomeric body mount member 14 with intermediate elastomer 20. FIG. 2 shows a high temperature >190° F. operating engine mount 10 made with first nonelastomeric engine mount member 12 and second nonelastomeric body mount member 14 with intermediate elastomer 20. FIG. 8A-D illustrate high temperature >190° F. operating engine mounts 10 controlling the motion of vehicle machine engines in a wheeled land vehicle truck and a marine vehicle boat. FIG. 3 shows a high temperature >190° F. operating mount 10 made with first nonelastomeric mount member 12 and second nonelastomeric body mount member 14 with intermediate elastomer 20. FIG. 4 show TEM photomicrographs of elastomer 20 with nonelastomeric nanosheets 30 dispersed in the elastomer composition (pointed at with white arrows in low magnification FIG. 4A, with FIG. 4B taken from the dotted white box of FIG. 4A). Mounts 10 as shown in FIG. 1-3 were made with intermediate elastomer 20 including dispersed nonelastomeric nanosheets 30 having a sheet aspect ratio of at least 5 to 1. The nanosheets 30 had an aspect ratio of at least 5 to 1 for a single nanosheet either in a stack or alone surrounded by elastomer 20. Preferably nanosheets 30 have at least a first planar dimension greater than 25 nm and at least one dimension less than 25 nm, preferably with a second planar dimension greater than 25 nm, and the at least one dimension less than 25 nm is the nanosheet thickness. Preferably the nanosheet thickness is preferably less than 2 nm, preferably with the nanosheet thickness centered about 1 nm (1±0.1 nm) with first and second normal planar direction dimensions greater than 25 nm. For a single nanosheets (multiple adjacent single nanosheets can make a stack of preferably 2 to 10, preferably stacks have no more than 20 adjacent nanosheets) the single nanosheet preferably has the aspect ratio of the planar length width dimension to the thickness dimension of at least 5 to 1, preferably at least 10 to 1, preferably at least 15 to 1, preferably at least 20 to 1, and most preferably at least 25 to 1 (at least 25 nm length or width planar dimension to 1 nm thickness dimension). For multiple adjacent single nanosheets in a stack, preferably the stack has no more than 20 adjacent nanosheets, and preferably the stack is comprised of 2 to 10 nanosheets. FIG. 1 FL elastomer mounts were made with intermediate elastomer 20 including dispersed nonelastomeric nanosheets 30 along with control mounts made with the elastomer absent the nanosheets 30. The FL elastomer mount tests cyclically worked the elastomer in the at least 190° F. operation environmental temperature of the heated laboratory test bed enclosure environment centered about 250° F. with mount testing displacements cycling at 4 Hz displacement frequency (0.5 inch displacements). In FIG. 5 the control mounts absent the nanosheets 30 are shown with dashed plot lines as compared with the nanosheet containing elastomer 20 shown with solid plot lines. The ends of the plot lines indicate the OL operational lifetime where the mount testing was terminated when the mount's elastomer failed to maintain an acceptable operational elastomer physical structural integrity level, with the elastomer in these FL mounts failure detected by the onset of mount fluid 22 leaking from the mount. FIG. 2 TF elastomer mounts were made with intermediate elastomer 20 including dispersed nonelastomeric nanosheets 30 along with control mounts made with the elastomer absent the nanosheets 30. The TF elastomer mounts were tested in the at least 190° F. high temperature operation environment heated laboratory test bed enclosure centered about 250° F. with mount testing displacements cycling at 2 Hz displacement frequency with displacements of plus/minus 0.125 inch. In FIG. 6 the control mounts absent the nanosheets 30 are shown with dashed plot lines as compared with the nanosheet containing elastomer 20 shown with solid plot lines. The ends of the plot lines indicate the OL operational lifetime where the mount's operational lifetime end spring rate SR_{E} reached 80% of the beginning spring rate (SR_{E}=0.8 SR_{B}). FIG. 3 TL elastomer mounts were made with intermediate elastomer 20 including dispersed nonelastomeric nanosheets 30 along with control mounts made with the elastomer absent the nanosheets 30. The TL elastomer mounts were tested in the heated laboratory test bed enclosure environment at 250° F. with mount testing displacements cycling at 10 Hz with a static displacement of +0.069″ and a dynamic of ±0.059″. In FIG. 7 the control mounts absent the nanosheets 30 are shown with dashed plot lines with triangles as compared with the nanosheet containing elastomer 20 shown with solid plot lines with circles. The ends of the plot lines indicate the OL operational lifetime where the mount's operational lifetime end spring rate SR_{E} reached 80% of the with beginning spring rate (SR_{E}=0.8 SR_{B}).

In an embodiment the invention includes a method of making a motion control device. The method includes providing a first nonelastomeric motion control device member. The method includes providing a second nonelastomeric motion control device member. The method includes disposing an elastomer between the first nonelastomeric motion control device member and the second nonelastomeric motion control device member wherein the elastomer is cyclically worked by a plurality of cyclic motions between the first nonelastomeric motion control device member and the second nonelastomeric motion control device member with the elastomer including a plurality of nonelastomeric nanosheets dispersed in the elastomer wherein the elastomer maintains an acceptable operational elastomer physical structural integrity level for a plurality of additional cyclic motions when the elastomer is cyclically worked in an operation environmental temperature of at least 190° F.

In an embodiment the method of making motion control device 10 includes providing first nonelastomeric motion control device member 12. The method includes providing second nonelastomeric motion control device member 14. The method includes disposing heat fatigue resistant elastomer 20 between the first nonelastomeric motion control device member and the second nonelastomeric motion control device member wherein the elastomer is cyclically worked by a plurality of cyclic motions between the first nonelastomeric motion control device member and the second nonelastomeric motion control device member with the heat resistant elastomer including the nonelastomeric nanosheets 30 dispersed in the elastomer wherein the elastomer 20 maintains an acceptable operational elastomer physical structural integrity level for a plurality of additional cyclic motions when the elastomer is cyclically worked in the operation environmental temperature of at least 190° F.

Preferably the method include providing the elastomer with the dispersed nanosheets 30 with the elastomer then providing more elastomer working cycles before the elastomer mount failure lifetime end cycle where a physical structural failure of elastomer occurs, such as with the elastomer breaking, tearing and/or cracking, and/or the device containing fluid has a fluid leak.

Preferably the motion control devices are made with the intermediate elastomer 20 including dispersed nonelastomeric nanosheets 30 having a sheet aspect ratio of at least 5 to 1. FIG. 1 (FL elastomer mount motion control device) shows a high temperature >190° F. operating motion control device 10 made with first nonelastomeric member 12 and second nonelastomeric member 14 with intermediate elastomer 20. FIG. 2 shows a high temperature >190° F. operating motion control device 10 made with first nonelastomeric member 12 and second nonelastomeric member 14 with intermediate elastomer 20. FIG. 3 shows a high temperature >190° F. operating motion control device 10 made with first nonelastomeric member 12 and second nonelastomeric member 14 with intermediate elastomer 20. FIG. 4 show TEM photomicrographs of elastomer 20 with nonelastomeric nanosheets 30 dispersed in the elastomer composition (pointed at with white arrows in low magnification FIG. 4A, with FIG. 4B taken from the dotted white box of FIG. 4A). Motion control devices 10 as shown in FIG. 1-3 were made with intermediate elastomer 20 including dispersed nonelastomeric nanosheets 30 having a sheet aspect ratio of at least 5 to 1. The nanosheets 30 had an aspect ratio of at least 5 to 1 for a single nanosheet either in a stack or alone surrounded by elastomer 20. Preferably nanosheets 30 have at least a first planar dimension greater than 25 nm and at least one dimension less than 25 nm, preferably with a second planar dimension greater than 25 nm, and the at least one dimension less than 25 nm is the nanosheet thickness. Preferably the nanosheet thickness is preferably less than 2 nm, preferably with the nanosheet thickness centered about 1 nm (1±0.1 nm) with first and second normal planar direction dimensions greater than 25 nm. For a single nanosheet (multiple adjacent single nanosheets can make a stack of preferably 2 to 10, preferably stacks have no more than 20 adjacent nanosheets) the single nanosheet preferably has the aspect ratio of the planar length width dimension to the thickness dimension of at least 5 to 1, preferably at least 10 to 1, preferably at least 15 to 1, preferably at least 20 to 1, and most preferably at least 25 to 1 (at least 25 nm length or width planar dimension to 1 nm thickness dimension). For multiple adjacent single nanosheets in a stack, preferably the stack has no more than 20 adjacent nanosheets, and preferably the stack is comprised of 2 to 10 nanosheets. FIG. 1 FL elastomer motion control devices were made with intermediate elastomer 20 including dispersed nonelastomeric nanosheets 30 along with control mounts made with the elastomer absent the nanosheets 30. The FL elastomer motion control device tests cyclically worked the elastomer in the at least 190° F. operation environmental temperature of the heated laboratory test bed enclosure environment centered about 250° F. with mount testing displacements cycling at 4 Hz displacement frequency (0.5 inch displacements). In FIG. 5 the controls absent the nanosheets 30 are shown with dashed plot lines as compared with the nanosheet containing elastomer 20 shown with solid plot lines. The ends of the plot lines indicate the OL operational lifetime where the testing was terminated when the devices' elastomer failed to maintain an acceptable operational elastomer physical structural integrity level, with the elastomer in these FL device failures detected by the onset of fluid 22 leaking. FIG. 2 TF elastomer devices were made with intermediate elastomer 20 including dispersed nonelastomeric nanosheets 30 along with control mounts made with the elastomer absent the nanosheets 30. The TF elastomer devices were tested in the at least 190° F. high temperature operation environment heated laboratory test bed enclosure centered about 250° F. with mount testing displacements cycling at 2 Hz displacement frequency with displacements of plus/minus 0.125 inch. In FIG. 6 the controls absent the nanosheets 30 are shown with dashed plot lines as compared with the nanosheet containing elastomer 20 shown with solid plot lines. The ends of the plot lines indicate the OL operational lifetime where the device's operational lifetime end spring rate SR_{E} reached 80% of the beginning spring rate (SR_{E}=0.8 SR_{B}). FIG. 3 TL elastomer devices were made with intermediate elastomer 20 including dispersed nonelastomeric nanosheets 30 along with controls made with the elastomer absent the nanosheets 30. The TL elastomer devices were tested in the heated laboratory test bed enclosure environment at 250° F. with mount testing displacements cycling at 10 Hz with a static displacement of +0.069″ and a dynamic of ±0.059″. In FIG. 7 the controls absent the nanosheets 30 are shown with dashed plot lines with triangles as compared with the nanosheet containing elastomer 20 shown with solid plot lines with circles. The ends of the plot lines indicate the OL operational lifetime where the device's operational lifetime end spring rate SR_{E} reached 80% of the with beginning spring rate (SR_{E}=0.8 SR_{B}).

In an embodiment the invention includes a method of making a motion control device. The method includes providing a first nonelastomeric motion control device member. The method includes providing a second nonelastomeric motion control device member. The method includes disposing an elastomer between the first nonelastomeric motion control device member and the second nonelastomeric motion control device member wherein the elastomer is cyclically worked by a plurality of cyclic motions between the first nonelastomeric motion control device member and the second nonelastomeric motion control device member with the elastomer including a plurality of nonelastomeric nanosheets dispersed in the elastomer wherein the elastomer maintains an acceptable operational spring rate level for a plurality of additional cyclic motions when the elastomer is cyclically worked in an operation environmental temperature of at least 190° F.

In an embodiment the method of making motion control device 10 includes providing a first nonelastomeric motion control device member 12. The method includes providing a second nonelastomeric motion control device member 14. The method includes disposing heat fatigue resistant elastomer 20 between the first nonelastomeric motion control device member and the second nonelastomeric motion control device member wherein the elastomer is cyclically worked by operational cyclic motions between the first nonelastomeric motion control device member and the second nonelastomeric motion control device member with the heat resistant elastomer including nonelastomeric nanosheets 30 dispersed in the elastomer wherein the elastomer maintains an acceptable operational spring rate level for additional cyclic motions when the elastomer is cyclically worked in an operation environmental temperature of at least 190° F. Preferably the method include providing the elastomer with the dispersed nanosheets 30 with the elastomer then providing more elastomer working cycles before the elastomer mount failure lifetime end cycle where a physical structural failure of elastomer occurs, such as with the elastomer breaking, tearing and/or cracking, and/or the device containing fluid has a fluid leak.

Preferably the motion control devices are made with the intermediate elastomer 20 including dispersed nonelastomeric nanosheets 30 having a sheet aspect ratio of at least 5 to 1. FIG. 1 (FL elastomer mount motion control device) shows a high temperature >190° F. operating motion control device 10 made with first nonelastomeric member 12 and second nonelastomeric member 14 with intermediate elastomer 20. FIG. 2 shows a high temperature >190° F. operating motion control device 10 made with first nonelastomeric member 12 and second nonelastomeric member 14 with intermediate elastomer 20. FIG. 3 shows a high temperature >190° F. operating motion control device 10 made with first nonelastomeric member 12 and second nonelastomeric member 14 with intermediate elastomer 20. FIG. 4 show TEM photomicrographs of elastomer 20 with nonelastomeric nanosheets 30 dispersed in the elastomer composition (pointed at with white arrows in low magnification FIG. 4A, with FIG. 4B taken from the dotted white box of FIG. 4A). Motion control devices 10 as shown in FIG. 1-3 were made with intermediate elastomer 20 including dispersed nonelastomeric nanosheets 30 having a sheet aspect ratio of at least 5 to 1. The nanosheets 30 had an aspect ratio of at least 5 to 1 for a single nanosheet either in a stack or alone surrounded by elastomer 20. Preferably nanosheets 30 have at least a first planar dimension greater than 25 nm and at least one dimension less than 25 nm, preferably with a second planar dimension greater than 25 nm, and the at least one dimension less than 25 nm is the nanosheet thickness. Preferably the nanosheet thickness is preferably less than 2 nm, preferably with the nanosheet thickness centered about 1 nm (1±0.1 nm) with first and second normal planar direction dimensions greater than 25 nm. For a single nanosheets (multiple adjacent single nanosheets can make a stack of preferably 2 to 10, preferably stacks have no more than 20 adjacent nanosheets) the single nanosheet preferably has the aspect ratio of the planar length width dimension to the thickness dimension of at least 5 to 1, preferably at least 10 to 1, preferably at least 15 to 1, preferably at least 20 to 1, and most preferably at least 25 to 1 (at least 25 nm length or width planar dimension to 1 nm thickness dimension). For multiple adjacent single nanosheets in a stack, preferably the stack has no more than 20 adjacent nanosheets, and preferably the stack is comprised of 2 to 10 nanosheets. FIG. 1 FL elastomer motion control devices were made with intermediate elastomer 20 including dispersed nonelastomeric nanosheets 30 along with control mounts made with the elastomer absent the nanosheets 30. The FL elastomer motion control device tests cyclically worked the elastomer in the at least 190° F. operation environmental temperature of the heated laboratory test bed enclosure environment centered about 250° F. with mount testing displacements cycling at 4 Hz displacement frequency (0.5 inch displacements). In FIG. 5 the controls absent the nanosheets 30 are shown with dashed plot lines as compared with the nanosheet containing elastomer 20 shown with solid plot lines. The ends of the plot lines indicate the OL operational lifetime where the testing was terminated when the devices' elastomer failed to maintain an acceptable operational elastomer physical structural integrity level, with the elastomer in these FL device failures detected by the onset of fluid 22 leaking. FIG. 2 TF elastomer devices were made with intermediate elastomer 20 including dispersed nonelastomeric nanosheets 30 along with control mounts made with the elastomer absent the nanosheets 30. The TF elastomer devices were tested in the at least 190° F. high temperature operation environment heated laboratory test bed enclosure centered about 250° F. with mount testing displacements cycling at 2 Hz displacement frequency with displacements of plus/minus 0.125 inch. In FIG. 6 the controls absent the nanosheets 30 are shown with dashed plot lines as compared with the nanosheet containing elastomer 20 shown with solid plot lines. The ends of the plot lines indicate the OL operational lifetime where the device's operational lifetime end spring rate SR_{E} reached 80% of the beginning spring rate (SR_{E}=0.8 SR_{B}). FIG. 3 TL elastomer devices were made with intermediate elastomer 20 including dispersed nonelastomeric nanosheets 30 along with controls made with the elastomer absent the nanosheets 30. The TL elastomer devices were tested in the heated laboratory test bed enclosure environment at 250° F. with mount testing displacements cycling at 10 Hz with a static displacement of +0.069″ and a dynamic of ±0.059″. In FIG. 7 the controls absent the nanosheets 30 are shown with dashed plot lines with triangles as compared with the nanosheet containing elastomer 20 shown with solid plot lines with circles. The ends of the plot lines indicate the OL operational lifetime where the device's operational lifetime end spring rate SR_{E} reached 80% of the with beginning spring rate (SR_{E}=0.8 SR_{B}).

In an embodiment the invention includes a method of making a machine component. The method includes providing a first nonelastomeric machine component member. The method includes bonding a >190° F. heat spring rate fatigue resistant elastomer to the first nonelastomeric machine component member with the >190° F. heat spring rate fatigue resistant elastomer including a plurality of dispersed nonelastomeric nanosheets to provide an at least 190° F. heat resistant machine component.

In an embodiment the method of making a machine component 10 includes providing at least a first nonelastomeric machine component member 12, 14. The method includes bonding a >190° F. heat spring rate fatigue resistant elastomer 20 to the at least first nonelastomeric machine component member with the >190° F. heat spring rate fatigue resistant elastomer including dispersed nonelastomeric nanosheets 30 to provide an at least 190° F. heat resistant machine component 10. Preferably the method include providing the elastomer with the dispersed nanosheets 30 with the elastomer then providing more elastomer working cycles before the elastomer machine component failure lifetime end cycle where a physical structural failure of elastomer occurs, such as with the elastomer breaking, tearing and/or cracking, and/or the device containing fluid has a fluid leak.

Preferably the motion control machine components are made with the intermediate elastomer 20 including dispersed nonelastomeric nanosheets 30 having a sheet aspect ratio of at least 5 to 1. FIG. 1 (FL elastomer machine component motion control device) shows a high temperature >190° F. operating motion control machine component 10 made with first nonelastomeric member 12 and second nonelastomeric member 14 with intermediate elastomer 20. FIG. 2 shows a high temperature >190° F. operating motion control machine component 10 made with first nonelastomeric member 12 and second nonelastomeric member 14 with intermediate elastomer 20. FIG. 3 shows a high temperature >190° F. operating motion control machine component 10 made with first nonelastomeric member 12 and second nonelastomeric member 14 with intermediate elastomer 20. FIG. 4 show TEM photomicrographs of elastomer 20 with nonelastomeric nanosheets 30 dispersed in the elastomer composition (pointed at with white arrows in low magnification FIG. 4A, with FIG. 4B taken from the dotted white box of FIG. 4A). Motion control machine components 10 as shown in FIG. 1-3 were made with intermediate elastomer 20 including dispersed nonelastomeric nanosheets 30 having a sheet aspect ratio of at least 5 to 1. The nanosheets 30 had an aspect ratio of at least 5 to 1 for a single nanosheet either in a stack or alone surrounded by elastomer 20. Preferably nanosheets 30 have at least a first planar dimension greater than 25 nm and at least one dimension less than 25 nm, preferably with a second planar dimension greater than 25 nm, and the at least one dimension less than 25 nm is the nanosheet thickness. Preferably the nanosheet thickness is preferably less than 2 nm, preferably with the nanosheet thickness centered about 1 nm (1±0.1 nm) with first and second normal planar direction dimensions greater than 25 nm. For a single nanosheets (multiple adjacent single nanosheets can make a stack of preferably 2 to 10, preferably stacks have no more than 20 adjacent nanosheets) the single nanosheet preferably has the aspect ratio of the planar length width dimension to the thickness dimension of at least 5 to 1, preferably at least 10 to 1, preferably at least 15 to 1, preferably at least 20 to 1, and most preferably at least 25 to 1 (at least 25 nm length or width planar dimension to 1 nm thickness dimension). For multiple adjacent single nanosheets in a stack, preferably the stack has no more than 20 adjacent nanosheets, and preferably the stack is comprised of 2 to 10 nanosheets. FIG. 1 FL elastomer motion control machine components were made with intermediate elastomer 20 including dispersed nonelastomeric nanosheets 30 along with control machine components made with the elastomer absent the nanosheets 30. The FL elastomer motion control machine component tests cyclically worked the elastomer in the at least 190° F. operation environmental temperature of the heated laboratory test bed enclosure environment centered about 250° F. with machine component testing displacements cycling at 4 Hz displacement frequency (0.5 inch displacements). In FIG. 5 the controls absent the nanosheets 30 are shown with dashed plot lines as compared with the nanosheet containing elastomer 20 shown with solid plot lines. The ends of the plot lines indicate the OL operational lifetime where the testing was terminated when the machine components' elastomer failed to maintain an acceptable operational elastomer physical structural integrity level, with the elastomer in these FL machine component failures detected by the onset of fluid 22 leaking. FIG. 2 TF elastomer machine components were made with intermediate elastomer 20 including dispersed nonelastomeric nanosheets 30 along with control machine components made with the elastomer absent the nanosheets 30. The TF elastomer machine components were tested in the at least 190° F. high temperature operation environment heated laboratory test bed enclosure centered about 250° F. with machine component testing displacements cycling at 2 Hz displacement frequency with displacements of plus/minus 0.125 inch. In FIG. 6 the controls absent the nanosheets 30 are shown with dashed plot lines as compared with the nanosheet containing elastomer 20 shown with solid plot lines. The ends of the plot lines indicate the OL operational lifetime where the machine component's operational lifetime end spring rate SR_{E} reached 80% of the beginning spring rate (SR_{E}=0.8 SR_{B}). FIG. 3 TL elastomer machine components were made with intermediate elastomer 20 including dispersed nonelastomeric nanosheets 30 along with controls made with the elastomer absent the nanosheets 30. The TL elastomer machine components were tested in the heated laboratory test bed enclosure environment at 250° F. with machine component testing displacements cycling at 10 Hz with a static displacement of +0.069″ and a dynamic of ±0.059″. In FIG. 7 the controls absent the nanosheets 30 are shown with dashed plot lines with triangles as compared with the nanosheet containing elastomer 20 shown with solid plot lines with circles. The ends of the plot lines indicate the OL operational lifetime where the machine component's operational lifetime end spring rate SR_{E} reached 80% of the with beginning spring rate (SR_{E}=0.8 SR_{B}).

In an embodiment the invention includes a method of making a vehicle. The method includes providing a vehicle having an operational environment temperature of at least 190 degrees Fahrenheit. The method includes providing a machine component, the machine component including an elastomer having a plurality of dispersed nonelastomeric nanosheets. The method includes installing the machine component in the vehicle wherein the elastomer is heated to at least 190 degrees Fahrenheit in the operational environment temperature of at least 190 degrees Fahrenheit.

In an embodiment the method of making a vehicle includes providing a vehicle having an operational environment temperature of at least 190 degrees Fahrenheit. The method includes providing the vehicle machine component 10, the machine component including an elastomer 20 having dispersed nonelastomeric nanosheets 30. The method includes installing the machine component 10 in the vehicle wherein the elastomer 20 is heated to at least 190 degrees Fahrenheit in the operational environment temperature of at least 190 degrees Fahrenheit. Installing machine component 10 includes installing the machine component 10 with an operational position wherein a tension load in the elastomer 20 is inhibited. In use preferably the machine component elastomer 20 is not under tension, preferably with the machine component installed with elastomer 20 used in compression and/or shear.

In an embodiment the invention includes a machine component. The machine component includes an intermediate elastomeric body, the intermediate elastomeric body providing an acceptable machine component spring rate performance operational lifetime. The intermediate elastomeric body is comprised of an elastomer having an elastomer composition, the elastomer including a plurality of dispersed nonelastomeric nanosheets, the dispersed nonelastomeric nanosheets having a first planar dimension greater than 25 nm, a second planar dimension greater than 25 nm, and a thickness dimension less than 2 nm, wherein the intermediate elastomeric body has an increased acceptable machine component spring rate performance operational lifetime above 190° F. relative to the elastomer composition absent the dispersed nonelastomeric nanosheets.

In an embodiment the machine component 10 includes the intermediate elastomeric body 20, the intermediate elastomeric body 20 providing the acceptable machine component spring rate performance operational lifetime. The intermediate elastomeric body 20 is comprised of the elastomer composition with dispersed nonelastomeric nanosheets 30, the dispersed nonelastomeric nanosheets 30 having a first planar dimension greater than 25 nm, a second planar dimension greater than 25 nm, and a thickness dimension less than 2 nm, wherein the intermediate elastomeric body 20 has the increased acceptable machine component spring rate performance operational lifetime above 190° F. relative to the elastomer composition absent the dispersed nonelastomeric nanosheets.

In an embodiment the invention includes a machine component. The machine component includes an intermediate elastomeric body, the intermediate elastomeric body providing an acceptable machine component spring rate performance operational lifetime, the intermediate elastomeric body comprised of a elastomer having an elastomer composition, the elastomer including a means for increasing the acceptable machine component spring rate performance operational lifetime in an above 190° F. operation temperature environment.

In an embodiment the machine component 10 includes intermediate elastomeric body 20, the intermediate elastomeric body 20 providing the acceptable machine component spring rate performance operational lifetime, the intermediate elastomeric body is comprised of an elastomer composition. The elastomer 20 includes a means for increasing the acceptable machine component spring rate performance operational lifetime in an above 190° F. operation temperature environment.

In an embodiment the invention includes a machine component. The machine component includes an intermediate elastomeric body, the intermediate elastomeric body providing an acceptable machine component elastomer structural integrity operational lifetime, the intermediate elastomeric body comprised of a elastomer having an elastomer composition, the elastomer including a plurality of dispersed nonelastomeric nanosheets, the dispersed nonelastomeric nanosheets having a first planar dimension greater than 25 nm, a second planar dimension greater than 25 nm, and a thickness dimension less than 2 nm, wherein the intermediate elastomeric body has an increased acceptable machine component operational lifetime above 190° F. relative to the elastomer composition absent the dispersed nonelastomeric nanosheets.

In an embodiment the machine component includes intermediate elastomeric body 20. The intermediate elastomeric body 20 provides an acceptable machine component elastomer structural integrity operational lifetime, the intermediate elastomeric body is comprised of a elastomer having an elastomer composition. The elastomer 20 includes the dispersed nonelastomeric nanosheets 30, the dispersed nonelastomeric nanosheets having a first planar dimension greater than 25 nm, a second planar dimension greater than 25 nm, and a thickness dimension less than 2 nm, wherein the intermediate elastomeric body has an increased acceptable machine component operational lifetime above 190° F. relative to the elastomer composition absent the dispersed nonelastomeric nanosheets.

In an embodiment the invention includes a machine component. The machine component includes an intermediate elastomeric body, the intermediate elastomeric body providing an acceptable machine component elastomer structural integrity operational lifetime, the intermediate elastomeric body comprised of a elastomer having an elastomer composition, the elastomer including a means for increasing the acceptable machine component operational lifetime in an above 190° F. operation temperature environment.

In an embodiment the machine component 10 includes intermediate elastomeric body 20, the intermediate elastomeric body providing an acceptable machine component elastomer structural integrity operational lifetime, the intermediate elastomeric body is comprised of a elastomer having an elastomer composition. The elastomer 20 including a means for increasing the acceptable machine component operational lifetime in an above 190° F. operation temperature environment.

In an embodiment the invention includes an engine mount. The engine mount includes an at least a first nonelastomeric engine mount member and an at least a second nonelastomeric mount member, and an intermediate elastomeric body bonded between the first nonelastomeric engine mount member and the second nonelastomeric mount member. The intermediate elastomeric body is comprised of a >210° F. heat resistant elastomer having a plurality of dispersed nonelastomeric nanosheets with a first planar dimension greater than 25 nm, a second planar dimension greater than 25 nm, and a thickness dimension less than 2 nm.

In an embodiment the engine mount 10 includes an at least a first nonelastomeric engine mount member 12 and an at least a second nonelastomeric mount member 14, and an intermediate elastomeric body 20 bonded between the first nonelastomeric engine mount member and the second nonelastomeric mount member. The intermediate elastomeric body 20 is comprised of a >210° F. heat resistant improved fatigue cycle elastomer having the dispersed nonelastomeric nanosheets 30 with a first planar dimension greater than 25 nm, a second planar dimension greater than 25 nm, and a thickness dimension less than 2 nm.

In an embodiment the invention includes a rubber to metal device for connecting a high temperature operating heat source to a body structure, the high temperature operating heat source having a heat source operation environment temperature of at least 190 degrees Fahrenheit. The rubber to metal device includes at least a first metal member for attachment to the high temperature operating heat source. The rubber to metal device includes at least a second metal member for attachment to the body structure. The rubber to metal device includes an intermediate rubber, the intermediate rubber disposed between the first metal member and the second metal member. The rubber to metal device has an operational lifetime beginning spring rate SR_{B} and an operational lifetime end spring rate SR_{E} with SR_{E}=0.8 SR_{B}, with an operational lifetime OL measured by a plurality of operational deflection cycles between the first metal member and the second metal member until the operational lifetime end spring rate SR_{E} is reached, wherein the rubber to metal device has an increased operational lifetime OL at the heat source operation environment temperature of at least 190 degrees Fahrenheit with the intermediate rubber including a plurality of dispersed nonelastomeric nanosheets having an aspect ratio of at least 5 to 1.

In an embodiment the rubber to metal device 10 includes the at least a first metal member 12 for attachment to the high temperature operating heat source. The rubber to metal device 10 includes the at least a second metal member 12 for attachment to the body structure. The rubber to metal device includes the intermediate rubber 20, the intermediate rubber 20 disposed between the first metal member and the second metal member. The rubber to metal device 10 has an operational lifetime beginning spring rate SR_{B} and an operational lifetime end spring rate SR_{E} with SR_{E}=0.8 SR_{B}, with an operational lifetime OL measured by a plurality of operational deflection cycles between the first metal member and the second metal member until the operational lifetime end spring rate SR_{E} is reached, wherein the rubber to metal device has an increased operational lifetime OL at the heat source operation environment temperature of at least 190 degrees Fahrenheit with the intermediate rubber 20 including dispersed nonelastomeric nanosheets 30 having a sheet aspect ratio of at least 5 to 1. Preferably the increased operational lifetime OL is at least ten percent greater than an operational lifetime of a second comparison rubber to metal device with the intermediate rubber absent the plurality of dispersed nonelastomeric nanosheets. Preferably the rubber to metal device has the increased operational lifetime OL with the heat source operation environment temperature at least 196 degrees Fahrenheit, preferably at least 208 degrees Fahrenheit, preferably at least 214 degrees Fahrenheit, preferably at least 220 degrees Fahrenheit, preferably at least 226 degrees Fahrenheit, preferably at least 232 degrees Fahrenheit, preferably at least 214 degrees Fahrenheit, preferably at least 238 degrees Fahrenheit, preferably at least 244 degrees Fahrenheit, and preferably at least 250 degrees Fahrenheit, and most preferably the high temperature is centered about 250 (250±10) degrees Fahrenheit.

Preferably the rubber includes a predetermined effective weight percentage amount of the dispersed nonelastomeric nanosheets 30 to provide the rubber to metal device with a substantial increase in the operational lifetime OL. Preferably the effective weight percentage range of nanosheets (nonorganic nonelastomer sheet weight) is in the range of 0.5 to 10 weight %, more preferably in the 1 to 5 weight % region in the elastomer composition. Preferably the increased operational lifetime OL is at least fifteen percent greater than an operational lifetime of a second comparison rubber to metal device with the intermediate rubber absent the plurality of dispersed nonelastomeric nanosheets preferably at least twenty five percent greater than an operational lifetime of a second comparison rubber to metal device with the intermediate rubber absent the plurality of dispersed nonelastomeric nanosheets, preferably at least fifty percent greater than an operational lifetime of a second comparison rubber to metal device with the intermediate rubber absent the plurality of dispersed nonelastomeric nanosheets, preferably at least seventy five percent greater than an operational lifetime of a second comparison rubber to metal device with the intermediate rubber absent the plurality of dispersed nonelastomeric nanosheets, preferably at least twice an operational lifetime of a second comparison rubber to metal device with the intermediate rubber absent the plurality of dispersed nonelastomeric nanosheets.

Preferably the operational deflection cycles compress the intermediate rubber. Preferably the operational deflection cycles shear the intermediate rubber. Preferably the operational deflection cycles compress and shear the intermediate rubber, preferably the rubber experiences shear and/or compression loading during operation, and preferably tension loading of rubber is inhibited. Preferably cycled tensioning of rubber is avoided. Preferably the rubber to metal device has a spring rate growth peak during the operational lifetime, with the spring rate growth peak at least one percent above the beginning spring rate SR_{B}, preferably with the spring rate growth peak at least five percent above the beginning spring rate SR_{B}. Preferably the rubber to metal device 10 contains a fluid 22. Preferably the operational lifetime OL is at least one and half million cycles, preferably at least one and three quarter million cycles, preferably at least two million cycles, preferably at least two and half million cycles, preferably at least three million cycles. Preferably the high temperature operating heat source is an internal combustion heat source. Preferably the body structure is a vehicle body structure. Preferably the dispersed nonelastomeric nanosheets have at least a first dimension greater than 25 nm and at least one thickness dimension less than 25 nm. Preferably the dispersed nonelastomeric nanosheets have a first planar dimension greater than 25 nm, a second planar dimension greater than 25 nm, and a thickness dimension less than 25 nm. Preferably the dispersed nonelastomeric nanosheets are comprised of silicon. Preferably the dispersed nonelastomeric nanosheets are comprised of aluminum.

In an embodiment the invention includes a method of making a rubber to metal device. The method includes providing a first metal member. The method includes providing a second nonelastomeric body member. The method includes disposing a heat resistant intermediate rubber between the first metal member and the second body member with the heat resistant intermediate rubber including a plurality of dispersed nonelastomeric nanosheets.

In an embodiment the method includes the making of rubber to metal device 10. The method includes providing first metal member 12. The method includes providing second nonelastomeric body member 14. The method includes disposing heat spring rate fatigue resistant intermediate rubber 20 between the first metal member and the second body member with the heat resistant intermediate rubber including dispersed nonelastomeric nanosheets 30. Preferably an operational deflection between the first metal member and the second body member compresses the heat resistant intermediate rubber 20, preferably with tensile loading and stressing of rubber 20 inhibited and avoided with the rubber to metal device disposition of rubber 20 between nonrubber rigid members 12, 14, preferably with the rubber utilized in compression and/or shear.

Preferably the heat resistant intermediate rubber 20 is comprised of a rubber composition with the nonelastomeric nanosheets 30 dispersed within the rubber composition. Preferably the method includes mixing nanosheet masterbatch with the rubber composition, preferably with a predetermined effective weight percentage amount of the dispersed nonelastomeric nanosheets to provide the rubber to metal device with a substantial increase in the operational lifetime OL, preferably with the nonorganic nonelastomer sheet mineral weight in the range of 0.5 to 10 weight %, more preferably in the 1 to 5 weight % region in the rubber composition.

In an embodiment the invention includes providing a masterbatch comprising an organoclay dispersed in a compatibilizer. The compatibilizer preferably comprises an olefinic compound having a slight polarity. The clay preferably comprises an organosilicate, a 2:1 multi-layered swellable silicate clay having a cationically exchangeable ion in its galleries. In an embodiment the invention includes providing a masterbatch. Preferably providing the masterbatch includes intercalating and at least partially exfoliating a clay in a compatibilizer to produce an at least partially exfoliated and dispersed clay masterbatch. By mixing the clay with a compatibilizer, the compatibilizer intercalates the galleries thereby swelling them slightly and allowing the shear forces created by mechanical mixing to break apart the galleries and at least partially exfoliate the clay. Once at least partially exfoliated, the individual clay platelets or small “stacks” of platelets can disperse throughout the compatibilizer. Continued shear force through mixing will further separate the galleries and better exfoliate the clay. In an embodiment of the invention the dispersed clay masterbatch is mixed with a non-polar elastomer to disperse the clay within the elastomer matrix and create an elastomer nanocomposite. Preferably the compatibilizer provides for the pre-dispersed clay to disperse freely in the elastomer matrix. In this manner an elastomer nanocomposite comprising a clay substantially exfoliated and dispersed in an elastomer is provided.

In an embodiment the invention nanosheets are substantially exfoliate and dispersed from a non-dispersed nanosheet material in a compatibilizer, so as to incorporate the substantially exfoliate and dispersed nanosheets into a high temperature elastomeric part such as an engine mount. In a preferred embodiment, the nanosheet comprises an organically modified clay. Preferably the term “substantially exfoliate” is defined as separating the individual layers of the clay so that at least half of the clay is present in particles having a minor dimension of less than or equal to 100 nm. In an idealized embodiment, all of the individual layers of clay will be separated from one another; however a 100% exfoliation is not realistic and not necessary to achieve the beneficial properties of the present invention. There will likely always be some intergallery attraction leading to agglomerations of greater than one layer.

Compatibilizers

In an embodiment, the compatibilizer functions to intercalate and swell the galleries of the clay and allow the clay to disperse within a liquid medium on a nano-scale. To achieve this dispersion, the compatibilizer must be able to swell the clay and separate at least some of the galleries from adjacent galleries. While the final dispersion may contain some inter-gallery connectivity, the majority of the intergallery bonding will have been broken.

While not wishing to be bound by the theory, it is believed that the hydrophilic moiety of the compatibilizer enters the spacing between and swells the galleries. This allows for the shear forces associated with mixing to break apart the clay into smaller pieces. The non-polar constituent of the compatibilizer then allows the platelets to be dispersed in a non-polar medium, such as natural rubber or some other elastomer. It is preferred that the molecular weight of the compatibilizer be low in order to allow all or a portion thereof to penetrate the galleries of the clay.

In an embodiment, the compatibilizer comprises an olefinic material having a slight polarity and a low molecular weight. One example of such a compatibilizer material comprises maleic anhydride adducted to an unsaturated olefinic polymer, such as maleated polybutadiene. Other useful resins may include polymers containing random mixtures of cis and trans 1,4, and 1,2 vinyl polybutadienes. This is due primarily because of their commercial availability, low viscosity and reactivity with maleic anhydride. It should be noted that high degrees of maleation can have detrimental effects on the finished rubber compound, and as such the degree of maleation is preferably kept below 10%. In an embodiment preferably the degree of maleation is less than 5%. Molecular weights can vary from a low of about 1600 to a high of more than 20,000 and still maintain useful handling properties. Compatibilizers with molecular weights above 20,000 tend not to be liquid at room temperature and processing temperature can restrict the ability to use such high molecular weight compatibilizers. Additionally, smaller molecular weight compatibilizers have greater ability to infiltrate the galleries of the clay.

Various polymer blends, alloys and dynamically vulcanized composites of maleated addition polymers based on polyethylenes, such as maleated polypropylenes, maleated styrene-ethylene-butene-styrene-block copolymers, maleated styrene-butadiene-styrene block copolymers, maleated ethylene-propylene rubbers, and blends thereof can be utilized as the compatibilizer in accordance with an embodiment of the present invention.

Clay

As used herein the term clay preferably refers to organically intercalated phyllosilicates, preferably layered silicates. Layered silicate nanocomposites are preferably derived from sodium montmorillonite, which is a member of the 2:1 layered smectite family of clays. Such clays are preferably composed of a sandwich type structure consisting of two outer tetrahedral layers, containing Si and O atoms, which is fused to an inner octahedral layer, containing Al and Mg atoms that are bonded to oxygen or hydroxyl groups; hence the 2:1 classification. Due to the isomorphous substitution of divalent Mg for trivalent Al, an electrostatic imbalance is created within the clay, resulting in an excess negative charge. Al is typically replaced with Mg, but can be also replaced by various other atoms such as Fe, Zn, Cr, and Li. The excess negative charge is counterbalanced by the adsorption of cations such as Na⁺ or Ca²⁺. The layer thickness of one layer of sodium montmorillonite is approximately 1 nm, while the lateral dimensions typically range from tens of nanometers to just under a micron, depending upon the source of the clay. Such dimensions translate into an enormous surface area, i.e. 750 m²/g. In the native state, individual layers are stacked on top of one another, similar to a deck of cards. Commercially refined sodium montmorillonite consists of agglomerates of stacks of clay platelet that form particles on the order of six microns in diameter.

Representative swellable layered materials comprise phyllosilicates, montmorillonite, sodium montmorillonite; magnesium montmorillonite; calcium montmorillonite; nontronite; beidellite; volchonskoite; hectorite; saponite; sauconite; sobockite; stevensite; svinfordite; or vermiculite.

In preferred embodiments, the invention includes dispersing the individual silicate sheets within a polymer matrix. However, this is not possible with native smectites. To make the clays more compatible with polymers and thus help facilitate clay-platelet dispersion, the cations in the clay are exchanged with cationic organic modifiers, such as an alkyl ammonium chloride. This reaction forms a swollen hybrid structure, termed an organoclay.

Preferably the provided the nanometer thick clay particles have such a large surface area, small quantities of clay can have an intimate interactions and compatibility with the host matrix, preferably the engine mount device elastomeric material.

Masterbatch

In one embodiment of the present invention, a masterbatch is prepared by mixing a clay with a compatibilizer. The compatibilizer enters and swells (intercalates) the galleries of the clay which allows shear force created through the mixing operation to separate the galleries thereby exfoliating and dispersing the clay in the compatibilizer. The resultant masterbatch comprises layers of clay dispersed within the compatibilizer wherein the clay generally ranges from 1 to about 20 layers in thickness. Generally, the greater the shear force experienced by the clay the greater the separation and dispersion of the individual layers within the compatibilizer.

The masterbatch process comprises the steps of mixing the clay with a compatibilizer to form a substantially exfoliated and dispersed masterbatch and to provide a high temperature masterbatch product for the intermediate elastomer which provides the intermediate elastomer into which it is incorporated with the dispersed nonelastomeric nanosheets having the aspect ratio of at least 5 to 1. Many of the suitable compatibilizers are solids at room temperature and must be heated at least to their melting point. Once in liquid form the clay is added and the components are mixed, preferably in a high speed mixer which increases the shear force experienced by clay. As the compatibilizer infiltrates and swells the galleries shear force breaks the layered clay into individual layers or small clusters of layers thereby exfoliating the material. Once the masterbatch is sufficiently mixed, the composition may be cooled and solidified for ease of storage and later incorporation into the intermediate elastomer.

In another embodiment of the invention, the concentration of clay in the masterbatch is expected to be much higher than the concentration of clay in a final intermediate elastomer nanocomposite. Generally, it is preferred that the clay is present in the masterbatch in an amount greater than 40 weight percent based on the total weight of the masterbatch, and less than 10 weight percent based on the total weight of the intermediate elastomer nanocomposite. Lower concentrations of clay in the masterbatch are acceptable, however longer mixing times will be required to create the shear forces necessary to substantially exfoliate and disperse the clay.

After the masterbatch has been prepared, with the clay substantially exfoliated and dispersed within the compatibilizer, the masterbatch is blended with the elastomer thereby dispersing the clay/compatibilizer in the intermediate elastomer. When incorporated by the masterbatch method, clays have been imparted improved functional properties to the elastomer nanocomposite at concentrations as low as 0.10 weight percent, based on the total weight of the nanocomposite. In one embodiment of the present invention, the clay is present in the nanocomposite in an amount ranging from 0.5 weight percent to 10 weight percent based on the total weight of the nanocomposite. In another embodiment of the present invention, the clay is present in the nanocomposite in an amount ranging from 1.0 weight percent to 5.0 weight percent based on the total weight of the nanocomposite.

Elastomer

The masterbatch compositions of the embodiments of the invention are preferably provided for dispersing the clays into the intermediate elastomers. Preferably the masterbatch compositions provides a means for dispersing clays in elastomers, and a means for providing a high temperature operating intermediate nanocomposite elastomer. The resulting nanocomposites, comprising an elastomer and a clay preferably provide the high temperature operating intermediate elastomer, as compared with the unfilled elastomer or elastomer filled with conventional (macro and larger) particles.

In one embodiment of the invention, the masterbatch compositions are employed to disperse clays in a non-polar or low-polarity, highly unsaturated elastomer. The elastomers may be blended by any suitable means with the masterbatch, however mixing which induces high shear is particularly preferred. As in the mixing of the masterbatch compositions, high shear aids in the further break up of the clay galleries and dispersion within the matrix material.

In a further embodiment of the invention, the elastomer comprises at least one of natural rubbers, polyisoprene rubber, poly(styrene-co-butadiene) rubber (SBR), polybutadiene rubber (BR), nitrile-butadiene rubber (NBR), poly(isoprene-co-butadiene) rubber (IBR), styrene-isoprene-butadiene rubber (SIBR), ethylene-propylene rubber (EPM), ethylene-propylene-diene rubber (EPDM), polysulfide, nitrile rubber, polychloroprene, neoprene, polyisoprene, propylene oxide polymers, star-branched butyl rubber and halogenated star-branched butyl rubber, brominated butyl rubber, chlorinated butyl rubber, star-branched polyisobutylene rubber, star-branched brominated butyl(polyisobutylene/isoprene copolymer) rubber, poly(isobutylene-co-p-methylstyrene), and halogenated poly(isobutylene-co-p-methylstyrene).

Fillers

As is understood by those of skill in the art, various commonly used additive materials may be added to the masterbatch or final nanocomposite elastomer such as, for example, curing aids, such as sulfur, activators, retarders and accelerators, processing additives, such as oils, resins including tackifying resins, silicas, and plasticizers, fillers, pigments, fatty acid, zinc oxide, waxes, antioxidants and antiozonants, peptizing agents and reinforcing materials such as, for example, calcium carbonate, and carbon black.

### EXAMPLES 1-4

Example 1 comprises a standard elastomer formulation comprising a blend of natural rubber and polybutadiene with N 326 carbon black, a roughly 300 nanometer carbon black particle filler. Example 2 comprises the same natural rubber/polybutadiene blend with the addition of a treated clay, Cloisite 20A. The direct addition of the Cloisite 20A to a natural rubber/polybutadiene blend results in poor dispersion. Large agglomerations of clay were visible in the rubber matrix (see FIG. 4C). In Example 3, a compatibilizing liquid polymer Ricon 131MA5 (5% maleic anhydride modified polybutadiene) is added to the rubber blend along with the Cloisite 20A. The result is still a poorly dispersed clay in rubber which is unsuitable for further testing or evaluation.

Each of Examples 1-4 also comprises additives such as antioxidants and antiozonants, as well as a cure package comprising a sulfur cure agent, sulfonamide accelerator, zinc oxide and steric acid. This additive and cure package was identical for Examples 1-4.

In Example 4, the clay is premixed in a 50:50 masterbatch with a compatibilizing liquid polymer Ricon 131MA5. The masterbatch is mixed then added to the rubber blend. The result is excellent dispersion of the clay in the rubber matrix and shows more reinforcement in the composite than an equivalent amount of N326 Carbon Black (Example 1) as evidenced by higher modulus values. In addition, the clay shows an improvement in heat aging when compared to the carbon black reinforced control as evidenced by the better retention of strength and elongation after heat aging.

| | 1 | 2 | 3 | 4 |
|---|---|---|---|---|
| Ingredient | | | | |
| Natural Rubber | 50.00 | 50.00 | 42.50 | 42.50 |
| Polybutadiene | 50.00 | 50.00 | 42.50 | 42.50 |
| Carbon Black (~300 nm) | 15.00 | | | |
| Cloisite 20A | | 15.00 | 15.00 | |
| Ricon 131MA5 | | | 15.00 | |
| 50:50 Cloisite/131MA5 | | | | 30.00 |
| masterbatch | | | | |
| Additives and Curative | 14.20 | 14.20 | 14.20 | 14.20 |
| PHYSICAL | | | | |
| PROPERTIES | | | | |
| Hardness (Shore A) | 41 | poor | poor | 51 |
| Tensile (psi) | 1620 | dispersion | dispersion | 2380 |
| Elongation (%) | 525 | | | 665 |
| 100% modulus (psi) | 170 | | | 385 |
| Oven age 70 hrs. @ | | | | |
| 100° C. | | | | |
| Tensile (PSI) | 765 | | | 2230 |
| Elongation (%) | 295 | | | 555 |
| Change in tensile (%) | −52.8 | | | −6.3 |
| Change in elongation (%) | −43.8 | | | −16.5 |
| Shear Modulus 10 Hz, | | | | |
| +/−10% strain | | | | |
| G′ (psi) | 109.4 | | | 178.4 |
| Tangent delta | 0.097 | | | 0.136 |
| 25% static G modulus | 88.6 | | | 128.5 |
| (psi) | | | | |

### EXAMPLES 5-7

There have been prior art attempts to disperse montmorillonite clays in latex (natural rubber for example) and the rubber is then coagulated with the clay in-situ. While this method of incorporating the clay into the compound avoids the dispersion problem of direct addition, it does not give properties that are as good as the masterbatch approach. Two parts of Cloisite 20A in masterbatch form (Example 6) reinforces similarly to 8 parts of N326 carbon black (Example 5). However, 2 parts of clay dispersed in latex (Example 7) reinforces similarly to only 4 parts of carbon black and does not yield very good tensile strength or heat aging resistance.

Each of Examples 5-7 also comprises additives such as antioxidants and antiozonants, as well as a cure package comprising a sulfur cure agent, sulfonamide accelerator, zinc oxide and steric acid. This additive and cure package was identical for Examples 5-7.

| | 5 | 6 | 7 |
|---|---|---|---|
| Ingredient | | | |
| Natural Rubber | 100.00 | 100.00 | 95.33 |
| Carbon Black (~300 nm) | 9.00 | 1.00 | 5.00 |
| 30% MMT in NR latex | | | 6.67 |
| 50% Cloisite 20A | | 4.00 | |
| masterbatch | | | |
| Additives and Curative | 13.10 | 13.10 | 13.10 |
| PHYSICAL | | | |
| PROPERTIES | | | |
| Hardness (Shore A) | 37 | 37 | 35 |
| Tensile (psi) | 3785 | 3475 | 2050 |
| Elongation (%) | 660 | 675 | 600 |
| 100% modulus (psi) | 135 | 145 | 130 |
| Oven age 70 hrs. @ 100° C. | | | |
| Tensile (PSI) | 3405 | 3340 | 1605 |
| Elongation (%) | 595 | 615 | 460 |
| Change in tensile (%) | −10.0 | −3.9 | −21.7 |
| Change in elongation (%) | −9.8 | −8.9 | −23.3 |
| Shear Modulus 10 Hz, +/−10% strain | | | |
| G′ (psi) | 73.5 | 76.0 | 72.0 |
| Tangent delta | 0.049 | 0.042 | 0.049 |
| 25% static G modulus | 67.0 | 69.7 | 65.1 |
| (psi) | | | |

### EXAMPLES 8-12

In Examples 10 the masterbatch process is extended to a synthetic clay (laponite), and in Examples 11 and 12 alternate compatibilizers, epoxy acrylate and urethane acrylate, respectively, are used to incorporate montmorillonite into the rubber blend.

Each of Examples 8-12 also comprises additives such as antioxidants and antiozonants, as well as a cure package comprising a sulfur cure agent, sulfonamide accelerator, zinc oxide and steric acid. This additive and cure package was identical for Examples 8-12.

| Ingredient | 8 | 9 | 10 | 11 | 12 |
|---|---|---|---|---|---|
| Natural Rubber CV-60 | 100.00 | 100.00 | 100.00 | 100.00 | 100.00 |
| Antidegradents and | 13.00 | 13.00 | 13.00 | 13.00 | 13.00 |
| activators | | | | | |
| N330 Carbon Black | 10.00 | 0.50 | 0.50 | 0.50 | 0.50 |
| Cloisite 20A in Ricon | | 7.00 | | | |
| 131MA5 | | | | | |
| Treated laponite in Ricon | | | 7.00 | | |
| 131MA5 | | | | | |
| 20A in CN104 epoxy | | | | 7.00 | |
| acrylate | | | | | |
| 20A in CN983 urethane | | | | | 7.00 |
| acrylate | | | | | |
| PVI Retarder | | 0.80 | 0.80 | 0.80 | 0.80 |
| Additives and Curatives | 4.50 | 4.50 | 4.50 | 4.50 | 4.50 |
| PHYSICAL | | | | | |
| PROPERTIES | | | | | |
| Hardness (Shore A) | 36 | 37 | 38 | 39 | 38 |
| Tensile (psi) | 3650 | 3720 | 3290 | 3425 | 3465 |
| Elongation (%) | 710 | 690 | 665 | 740 | 750 |
| 100% modulus (psi) | 135 | 160 | 130 | 145 | 145 |
| Oven age 70 hrs. @ 100° C. | | | | | |
| Tensile (PSI) | 3090 | 3705 | 2495 | 3640 | 3350 |
| Elongation (%) | 565 | 600 | 605 | 930 | 630 |
| Change in tensile (%) | −15.3 | −0.4 | −24.2 | 6.3 | −3.3 |
| Change in elongation (%) | −20.4 | −13.0 | −9.0 | 25.7 | −16.0 |
| Shear Modulus 10 Hz, +/−10% strain | | | | | |
| G′ (psi) | 82.7 | 88.3 | 80.3 | 103.5 | 101.9 |
| Tangent delta | 0.055 | 0.067 | 0.051 | 0.094 | 0.114 |
| 25% static G modulus | 74.8 | 75.8 | 72.8 | 82.5 | 78.8 |
| (psi) | | | | | |

Ricon 131MA5, CN104 and CN983 are all available from Sartomer.

| | Masterbatch materials used in examples | | | | | |
|---|---|---|---|---|---|---|
| Ingredient | — | — | 9 | 10 | 11 | 12 |
| Cloisite 20A* | 100 | 0 | 50 | 0 | 50 | 50 |
| Laponite with | 0 | 100 | 0 | 54 | 0 | 0 |
| 20A treatment** | | | | | | |
| NR | 0 | 0 | 25 | 23 | 25 | 25 |
| Ricon 131MA5 | 0 | 0 | 25 | 23 | 0 | 0 |
| CN104 epoxy acrylate | 0 | 0 | 0 | 0 | 25 | 0 |
| CN983 urethane acrylate | 0 | 0 | 0 | 0 | 0 | 25 |
| Morphological data | | | | | | |
| via Low Angle X-Ray | | | | | | |
| Diffraction | | | | | | |
| d₀₀₁ basal spacing (nm) | 2.52 | — | 4.62 | 5.22 | 3.57 | 3.71 |

*Cloisite 20A is dihydrogenated dimethyl ammonium modified montmorillonite, where montmorillonite comes from naturally occurring sodium montmorillonite
**Synthetic layered silicate treated with same ammonium modification as Cloisite 20A.

The chart above illustrates the d-spacing obtained via x-ray diffraction on the materials used in examples 9-12. Comparison of d-spacings of the raw organoclays versus those of the masterbatch materials provides insight as to how well the polar, liquid compatibilizer intercalates the clay in the masterbatch material. FIG. 4A-B are transmission photomicrograph of example 9 showing that the masterbatch process leads to well-dispersed clay platelets in the final rubber compound.

### EXAMPLES 13-19

Examples 13-19 illustrate other liquid polymers suitable for use as the compatibilizer in the masterbatch and to allow exfoliation and dispersion of the clay. A polar plasticizer such as dioctyl sebacate also works as long as it is used with a high molecular weight polymer to make the resulting masterbatch processable. Heat resistance improvement is conveyed by each of these compatibilizer clay blends.

Each of Examples 13-19 also comprises additives such as antioxidants, antiozonants and pre-vulcanization inhibitors, as well as a cure package comprising a sulfur cure agent, sulfonamide accelerator, zinc oxide and steric acid. This additive and cure package was identical for Examples 14-19, with the prevulcanization inhibitor excluded from example 13.

| Ingredient | 13 | 14 | 15 | 16 | 17 | 18 | 19 |
|---|---|---|---|---|---|---|---|
| Natural Rubber | 50.00 | 50.00 | 50.00 | 50.00 | 50.00 | 50.00 | 47.50 |
| Medium cis polybutadiene | 50.00 | 50.00 | 50.00 | 50.00 | 50.00 | 50.00 | 50.00 |
| Antidegradents and | 12.33 | 12.33 | 12.33 | 12.33 | 12.33 | 12.33 | 12.33 |
| activators | | | | | | | |
| N326 Carbon Black | 52.00 | 47.00 | 47.00 | 47.00 | 47.00 | 47.00 | 47.00 |
| 67% Cloisite 20A in | | 7.50 | | | | | |
| Ricon 131MA5 | | | | | | | |
| 57% Cloisite 20A in | | | 8.75 | | | | |
| Ricon 184MA6 | | | | | | | |
| 59% Cloisite 20A in | | | | 8.50 | | | |
| Ricacryl 3801 | | | | | | | |
| 66% Cloisite 20A in | | | | | 7.50 | | |
| Hycar 2000X162 | | | | | | | |
| 66% Cloisite 20A in | | | | | | 7.50 | |
| Hycar 1300X31 | | | | | | | |
| 50% Cloisite 20A in 50:50 | | | | | | | 10.00 |
| DOS and NR | | | | | | | |
| Additives and Curatives | 2.4 | 2.80 | 2.80 | 2.80 | 2.80 | 2.80 | 2.80 |
| PHYSICAL | | | | | | | |
| PROPERTIES | | | | | | | |
| Hardness (Shore A) | 58 | 59 | 60 | 59 | 60 | 57 | 56 |
| Tensile (psi) | 2950 | 3220 | 2915 | 2935 | 3000 | 2830 | 3295 |
| Elongation (%) | 570 | 650 | 615 | 665 | 665 | 690 | 610 |
| 100% modulus (psi) | 280 | 290 | 300 | 270 | 275 | 245 | 270 |
| Oven age 70 hrs. @ | | | | | | | |
| 100° C. | | | | | | | |
| Tensile (PSI) | 2170 | 2810 | 2845 | 2820 | 2945 | 2555 | 2885 |
| Elongation (%) | 310 | 435 | 400 | 420 | 430 | 425 | 365 |
| Change in tensile (%) | −26.4 | −12.7 | −2.4 | −3.9 | −1.8 | −9.7 | −12.4 |
| Change in elongation (%) | −45.6 | −33.1 | −35.0 | −36.8 | −35.3 | −38.4 | −40.2 |
| Shear Modulus 10 Hz, +/−10% strain | | | | | | | |
| G′ (psi) | 248.9 | 268.1 | 277.0 | 280.2 | 283.1 | 274.4 | 229.3 |
| Tangent delta | 0.206 | 0.222 | 0.222 | 0.238 | 0.242 | 0.257 | 0.232 |
| 25% static G modulus | 168.4 | 175.7 | 177.7 | 179.1 | 175.1 | 165.1 | 151.6 |
| (psi) | | | | | | | |

Ricon 131MA5: liquid polybutadiene adducted with 5% maleic anhydride
Ricon 184MA6: liquid styrene-butadiene adducted with 6% maleic anhydride
Ricacryl 3801: Aliphatic acrylate/methacrylate oligomer
Hycar 2000X162: Carboxy terminated liquid polybutadiene polymer
Hycar 1300X31: Carboxy terminated liquid butadiene-acrylonitrile polymer
DOS and NR: Dioctyle Sebacate plasticizer in Natural Rubber

| | Masterbatch materials used in examples | | | | | | | |
|---|---|---|---|---|---|---|---|---|
| Ingredient (wt %) | — | — | 14 | 15 | 16 | 17 | 18 | 19 |
| Cloisite 20A* (organically modified | 100 | 57 | 67 | 57 | 59 | 67 | 67 | 50 |
| montmorillonite) | | | | | | | | |
| Ricon 131MA5 (maleated | 0 | 43 | 33 | 0 | 0 | 0 | 0 | 0 |
| polybutadiene) | | | | | | | | |
| Ricon 184MA6 (maleated | 0 | 0 | 0 | 43 | 0 | 0 | 0 | 0 |
| styrene/butadiene copoly) | | | | | | | | |
| Ricacryl 3801 (methacrylated | 0 | 0 | 0 | 0 | 41 | 0 | 0 | 0 |
| polybutadiene) | | | | | | | | |
| Hycar 2000X162 (carboxy terminated | 0 | 0 | 0 | 0 | 0 | 33 | 0 | 0 |
| polybutadiene) | | | | | | | | |
| Hycar 1300X31 (amine term. | 0 | 0 | 0 | 0 | 0 | 0 | 33 | 0 |
| polybutadiene acrylonitrile copoly) | | | | | | | | |
| Dioctyl sebacate | 0 | 0 | 0 | 0 | 0 | 0 | 0 | 25 |
| NR (natural rubber) | 0 | 0 | 0 | 0 | 0 | 0 | 0 | 25 |
| Morphological data via Low Angle X- | | | | | | | | |
| Ray Diffraction | | | | | | | | |
| d₀₀₁ basal spacing (nm) | 2.54 | 6.08 | 4.02 | 5.61 | 4.53 | 3.58 | 3.90 | 3.82 |

*Cloisite 20A is dihydrogenated dimethyl ammonium modified montmorillonite, where montmorillonite comes from naturally occurring sodium montmorillonite

The table above includes X-ray data for the masterbatch materials corresponding to examples 14-19. Comparison of d-spacings of the raw organoclay 20A versus those of the masterbatch materials provides insight as to how well the polar, liquid compatibilizer intercalates the clay in the masterbatch material. The best intercalation of the organoclay by the compatibilizer is obtained by the maleated-PB (Ricon MA131MA5) when compared on an equal parts clay/compatibilizer basis.

### EXAMPLES 20-23

Liquid polyisoprene acts as a compatibilizing liquid. However, non-polar (non-functionalized) liquid polyisoprene (Example 23) does not show as much stiffness increase as a polyisoprene with some polarity such as carboxyl groups (Example 21) or methacryl groups (Example 22). The non-polar polyisoprene is less effective for enabling intercalation and/or exfoliation.

Each of Examples 20-23 also comprises additives such as antioxidants and antiozonants, as well as a cure package comprising a sulfur cure agent, sulfonamide accelerator, zinc oxide and steric acid. This additive and cure package was identical for Examples 20-23.

| | 20 | 21 | 22 | 23 |
|---|---|---|---|---|
| Ingredient | | | | |
| Natural Rubber | 100.00 | 100.00 | 100.00 | 100.00 |
| Carbon Black (~300 nm) | 52.00 | 47.00 | 47.00 | 47.00 |
| 57% Cloisite 20A in | | 8.75 | | |
| LIR-UC203 | | | | |
| 57% Cloisite 20A in | | | 8.75 | |
| LIR-410 | | | | |
| 57% Cloisite 20A in | | | | 8.75 |
| LIR-30 | | | | |
| Additives and Curatives | 14.73 | 14.73 | 14.73 | 14.73 |
| PHYSICAL | | | | |
| PROPERTIES | | | | |
| Hardness (Shore A) | 52 | 59 | 61 | 59 |
| Tensile (psi) | 4065 | 4150 | 4065 | 4090 |
| Elongation (%) | 635 | 485 | 505 | 540 |
| 100% modulus (psi) | 255 | 395 | 370 | 335 |
| Shear Modulus 10 Hz, | | | | |
| +/−10% strain | | | | |
| G′ (psi) | 195.4 | 221.8 | 226.0 | 210.1 |
| Tangent delta | 0.194 | 0.178 | 0.174 | 0.206 |
| 25% static G modulus | 141.2 | 161.4 | 160.5 | 149.2 |
| (psi) | | | | |

LIR-30: liquid polyisoprene polymer
LIR-410: liquid polyisoprene polymer adducted with 10% carboxyl groups
LIR-UC203: liquid polyisoprene polymer adducted with 3% methacryl groups

| | Masterbatch materials | | | |
|---|---|---|---|---|
| | used in examples | | | |
| Ingredient (wt %) | — | 21 | 22 | 23 |
| Cloisite 20A* (organically modified | 100 | 57 | 57 | 57 |
| montmorillonite) | | | | |
| LIR-UC203 (methacrylated polyisoprene) | 0 | 43 | 0 | 0 |
| LIR-410 (carboxylated polyisoprene) | 0 | 0 | 43 | 0 |
| LIR-30 (non-functionalized polyisoprene) | 0 | | 0 | 43 |
| Morphological data via Low Angle X-Ray | | | | |
| Diffraction | | | | |
| d₀₀₁ basal spacing (nm) | 2.54 | 3.60 | 5.44 | 2.58 |

*Cloisite 20A is dihydrogenated dimethyl ammonium modified montmorillonite, where montmorillonite comes from naturally occurring sodium montmorillonite

The table above includes X-ray data for the masterbatch materials corresponding to examples 21-23. Comparison of d-spacings of the raw organoclay 20A versus those of the masterbatch materials provides insight as to how well the liquid compatibilizer intercalates the clay in the masterbatch material. Note that the d-spacing of the masterbatch material based on non-polar (non-functionalized) is identical to that of the raw organoclay 20A, indicating that the compatibilizer failed to enter the galleries of the clay. This lack of interaction is also reflective in the final rubber compound (Example 23), in that the properties are inferior to that of examples 21 and 22. In general, less exfoliation of the clay results in less improvement in mechanical properties.

### EXAMPLES 24-28

Examples 24 to 28 illustrate clay masterbatches incorporated into other elastomers including acrylonitrile-butadiene copolymers (NBR), hydrogenated nitriles (HNBR), polychloroprenes (CR), ethylene propylene rubber (EPDM and EPR), and ethylene acrylic (AEM). Non-liquid (thermoplastic) polymers can be used as the compatibilizer as long as they melt and become liquid at processing temperatures (melt point below 150 degrees C.). Examples of useful thermoplastic resins include various modified ethylene vinyl acetate polymers (Examples 26 and 27).

Each of Examples 24-28 also comprises additives such as antioxidants, processing aids, and curatives. The additives where identical for Examples 24-28.

| Ingredient | 24 | 25 | 26 | 27 | 28 |
|---|---|---|---|---|---|
| Vamac G ethylene acrylic rubber | 100.00 | 100.00 | 100.00 | 100.00 | 100.00 |
| N774 Carbon Black | 20.00 | 15.00 | 15.00 | 15.00 | 15.00 |
| N650 Carbon Black | 25.00 | 25.00 | 25.00 | 25.00 | 25.00 |
| 67% Cloisite 20A in Ricon 131MA5 | | 7.50 | | | |
| 57% Cloisite 20A in Fusabond | | | 7.50 | | |
| MC190D | | | | | |
| 57% Cloisite 20A in Bynel | | | | 7.50 | |
| CXA1124 | | | | | |
| 59% Cloisite 20A in Ricacryl 3801 | | | | | 7.50 |
| Additives and Curative | 11.75 | 11.75 | 11.75 | 11.75 | 11.75 |
| PHYSICAL PROPERTIES | | | | | |
| Hardness (Shore A) | 56 | 60 | 63 | 61 | 60 |
| Tensile (psi) | 2250 | 2280 | 2190 | 2095 | 2025 |
| Elongation (%) | 385 | 480 | 460 | 485 | 440 |
| 100% modulus (psi) | 465 | 430 | 465 | 445 | 430 |
| Shear Modulus 10 Hz, +/−10% strain | | | | | |
| G′ (psi) | 232.8 | 230.0 | 238.7 | 244.0 | 239.8 |
| Tangent delta | 0.274 | 0.348 | 0.334 | 0.328 | 0.324 |
| 25% static G modulus (psi) | 126.4 | 125.5 | 127.0 | 141.5 | 130.1 |

Ricon 131MA5: liquid polybutadiene adducted with 5% maleic anhydride
Fusabond MC190D: chemically modified ethylene vinyl acetate containing a nominal VA level of 28%
Bynel CXA1124: acid modified ethylene vinyl acetate polymer
Ricacryl 3801: Aliphatic acrylate/methacrylate oligomer

| | Masterbatch materials used in examples | | | | | |
|---|---|---|---|---|---|---|
| Ingredient (wt %) | — | — | 25 | 26 | 27 | 28 |
| Cloisite 20A* (organically modified | 100 | 57 | 67 | 57 | 57 | 59 |
| montmorillonite) | | | | | | |
| Ricon 131MA5 | 0 | 43 | 33 | 0 | 0 | 0 |
| Fusabond MC190D | 0 | 0 | 0 | 43 | 0 | 0 |
| Bynel CXA1124 | 0 | 0 | 0 | 0 | 43 | 0 |
| Ricacryl 3801 | 0 | 0 | 0 | 0 | 0 | 41 |
| Morphological data via Low Angle X-Ray | | | | | | |
| Diffraction | | | | | | |
| d₀₀₁ basal spacing (nm) | 2.54 | 6.08 | 4.02 | 4.09 | 4.22 | 4.53 |

*Cloisite 20A is dihydrogenated dimethyl ammonium modified montmorillonite, where montmorillonite comes from naturally occurring sodium montmorillonite
Ricon 131MA5: liquid polybutadiene adducted with 5% maleic anhydride
Fusabond MC190D: chemically modified ethylene vinyl acetate containing a nominal VA level of 28%
Bynel CXA1124: acid modified ethylene vinyl acetate polymer
Ricacryl 3801: Aliphatic acrylate/methacrylate oligomer

The table above includes X-ray data for the masterbatch materials corresponding to examples 25-28. Comparison of d-spacings of the raw organoclay 20A versus those of the masterbatch materials provides insight as to how well the liquid compatibilizer, including molten thermoplastic type resins, intercalates the clay in the masterbatch material.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

What is claimed is:

1. An engine mount for isolating a high temperature operating engine from a body structure, said high temperature operating engine having an engine operation environment temperature of at least 190 degrees Fahrenheit, said engine mount including:
an at least a first nonelastomeric engine mount member for attachment to said high temperature operating engine,
an at least a second nonelastomeric body mount member for attachment to said body structure,
an intermediate elastomer, said intermediate elastomer disposed between said
first nonelastomeric engine mount member and said second nonelastomeric body mount member,
said engine mount having an operational lifetime beginning spring rate SR_{B} and an operational lifetime end spring rate SR_{E} with SR_{E}=0.8 SR_{B}, with an operational lifetime OL measured by a plurality of operational deflection cycles between said first nonelastomeric engine mount member and said second nonelastomeric body mount member until said operational lifetime end spring rate SR_{E} is reached, wherein said engine mount has an increased operational lifetime OL at said engine operation environment temperature of at least 190 degrees Fahrenheit with
said intermediate elastomer including a plurality of dispersed nonelastomeric nanosheets having an aspect ratio of at least 5 to 1.

2. An engine mount as claimed in claim 1 wherein said increased operational lifetime OL is at least ten percent greater than an operational lifetime of a second comparison engine mount with said intermediate elastomer absent said plurality of dispersed nonelastomeric nanosheets.

3. An engine mount as claimed in claim 1 wherein said engine mount has said increased operational lifetime OL with said engine operation environment temperature at least 214 degrees Fahrenheit.

4. An engine mount as claimed in claim 1 wherein said engine mount has said increased operational lifetime OL with said engine operation environment temperature at least 232 degrees Fahrenheit.

5. An engine mount as claimed in claim 1 wherein said engine mount has said increased operational lifetime OL with said engine operation environment temperature at least 244 degrees Fahrenheit.

6. An engine mount as claimed in claim 1 wherein said engine mount has said increased operational lifetime OL with said engine operation environment temperature at least 250 degrees Fahrenheit.

7. An engine mount as claimed in claim 1 wherein said elastomer includes a predetermined amount of said dispersed nonelastomeric nanosheets to provide said engine mount with a substantial increase in said operational lifetime OL.

8. An engine mount as claimed in claim 1 wherein said increased operational lifetime OL is at least fifty percent greater than an operational lifetime of a second comparison engine mount with said intermediate elastomer absent said plurality of dispersed nonelastomeric nanosheets.

9. An engine mount as claimed in claim 1 wherein said increased operational lifetime OL is at least seventy five percent greater than an operational lifetime of a second comparison engine mount with said intermediate elastomer absent said plurality of dispersed nonelastomeric nanosheets.

10. An engine mount as claimed in claim 1 wherein said increased operational lifetime OL is at least twice an operational lifetime of a second comparison engine mount with said intermediate elastomer absent said plurality of dispersed nonelastomeric nanosheets.

11. An engine mount as claimed in claim 1 wherein said operational deflection cycles compress said intermediate elastomer.

12. An engine mount as claimed in claim 1 wherein said operational deflection cycles shear said intermediate elastomer.

13. An engine mount as claimed in claim 1 wherein said operational deflection cycles compress and shear said intermediate elastomer.

14. An engine mount as claimed in claim 1 wherein said engine mount has a spring rate growth peak during said operational lifetime, with said spring rate growth peak at least one percent above said beginning spring rate SR_{B}.

15. An engine mount as claimed in claim 1 wherein said engine mount has a spring rate growth peak during said operational lifetime, with said spring rate growth peak at least five percent above said beginning spring rate SR_{B}.

16. An engine mount as claimed in claim 1 wherein said engine mount contains a fluid.

17. An engine mount as claimed in claim 1 wherein said operational lifetime OL is at least one and half million cycles.

18. An engine mount as claimed in claim 1 wherein said operational lifetime OL is at least two million cycles.

19. An engine mount as claimed in claim 1 wherein said operational lifetime OL is at least three million cycles.

20. An engine mount as claimed in claim 1 wherein said high temperature operating engine is an internal combustion engine.

21. An engine mount as claimed in claim 1 wherein said body structure is a vehicle body structure.

22. An engine mount as claimed in claim 1 wherein said dispersed nonelastomeric nanosheets have at least a first dimension greater than 25 nm and at least one thickness dimension less than 25 nm.

23. An engine mount as claimed in claim 1 wherein said dispersed nonelastomeric nanosheets have a first planar dimension greater than 25 nm, a second planar dimension greater than 25 nm, and a thickness dimension less than 25 nm.

24. An engine mount as claimed in claim 1 wherein said dispersed nonelastomeric nanosheets are comprised of silicon.

25. An engine mount as claimed in claim 1 wherein said dispersed nonelastomeric nanosheets are comprised of aluminum.

26. A method of making an engine mount, said method including:
providing a first nonelastomeric engine mount member,
providing a second nonelastomeric body member,
disposing a heat resistant intermediate elastomer between said first nonelastomeric engine mount member and said second body member with said
said heat resistant intermediate elastomer including a plurality of dispersed nonelastomeric nanosheets.

27. A method of making an engine mount as claimed in claim 26 wherein an operational deflection between said first nonelastomeric engine mount member and said second body member compresses said heat resistant intermediate elastomer.

28. A method of making an engine mount as claimed in claim 26 wherein an operational deflection between said first nonelastomeric engine mount member and said second body member shears said heat resistant intermediate elastomer.

29. A method of making an engine mount as claimed in claim 26 wherein an operational deflection between said first nonelastomeric engine mount member and said second body member compresses and shears said heat resistant intermediate elastomer.

30. A method of making an engine mount as claimed in claim 26 wherein said heat resistant intermediate elastomer is comprised of an elastomeric composition with said nonelastomeric nanosheets dispersed within said elastomeric composition.

31. A method of making an engine mount as claimed in claim 30, includes mixing a nanosheet masterbatch with said elastomeric composition.

32. A method of making an engine mount as claimed in claim 26 wherein said intermediate elastomer provides an operational lifetime beginning spring rate SR_{B} and an operational lifetime end spring rate SR_{E} with SR_{E}=0.8 SR_{B}, with an operational lifetime OL measured by a plurality of operational deflection cycles between said first nonelastomeric member and said second nonelastomeric member until said operational lifetime end spring rate SR_{E} is reached, wherein said engine mount has an increased operational lifetime OL at an engine operation environment temperature of at least 190 degrees Fahrenheit.

33. A method as claimed in claim 32 wherein said increased operational lifetime OL is at least ten percent greater than an operational lifetime of a second comparison engine mount with said intermediate elastomer absent said plurality of dispersed nonelastomeric nanosheets.

34. A method as claimed in claim 32 wherein said increased operational lifetime OL is at least one and half million cycles.

35. A method of making an engine mount as claimed in claim 26 wherein said intermediate elastomer provides an operational lifetime OL measured by a plurality of operational deflection cycles between a first deflection cycle and a elastomer mount failure lifetime end cycle with the operational deflection cycles between said first nonelastomeric member and said second nonelastomeric member, wherein said engine mount has an increased operational lifetime OL at an engine operation environment temperature of at least 190 degrees Fahrenheit.

36. A method of making an engine mount as claimed in claim 26 wherein said intermediate elastomer provides an increased operational lifetime OL at least ten percent greater than an operational lifetime of a second comparison engine mount made with said intermediate elastomer absent said plurality of dispersed nonelastomeric nanosheets.

37. A method of making an engine mount as claimed in claim 36 wherein said engine mount has said increased operational lifetime OL with an engine operation environment temperature at least 196 degrees Fahrenheit.

38. A method of making an engine mount as claimed in claim 36 wherein said engine mount has said increased operational lifetime OL with an engine operation environment temperature at least 220 degrees Fahrenheit.

39. A method of making an engine mount as claimed in claim 36 wherein said engine mount has said increased operational lifetime OL with an engine operation environment temperature at least 238 degrees Fahrenheit.

40. A method of making an engine mount as claimed in claim 36 wherein said engine mount has said increased operational lifetime OL at least fifteen percent greater than said operational lifetime of said second comparison engine mount with said intermediate elastomer absent said plurality of dispersed nonelastomeric nanosheets.

41. A method of making an engine mount as claimed in claim 26 wherein said method includes providing a mount fluid and containing said mount fluid in said engine mount with said intermediate elastomer.

42. A method of making an engine mount as claimed in claim 26 wherein said first nonelastomeric engine mount member is provided for connection proximate a high temperature operating internal combustion engine.

43. A method of making an engine mount as claimed in claim 26 wherein said second nonelastomeric body member is provided for connection proximate a vehicle body structure.

44. A method of making a motion control device, said method including:
providing a first nonelastomeric motion control device member,
providing a second nonelastomeric motion control device member,
disposing elastomer between said first nonelastomeric motion control device member and said second nonelastomeric motion control device member wherein said elastomer is cyclically worked by a plurality of cyclic motions between said first nonelastomeric motion control device member and said second nonelastomeric motion control device member with said elastomer including a plurality of nonelastomeric nanosheets dispersed in said elastomer wherein said elastomer maintains an acceptable operational elastomer physical structural integrity level for a plurality of additional cyclic motions when said elastomer is cyclically worked in an operation environmental temperature of at least 190° F.

45. A method of making a motion control device, said method including:
providing a first nonelastomeric motion control device member,
providing a second nonelastomeric motion control device member,
disposing an elastomer between said first nonelastomeric motion control device member and said second nonelastomeric motion control device member wherein said elastomer is cyclically worked by a plurality of cyclic motions between said first nonelastomeric motion control device member and said second nonelastomeric motion control device member with said elastomer including a plurality of nonelastomeric nanosheets dispersed in said elastomer wherein said elastomer maintains an acceptable operational spring rate level for a plurality of additional cyclic motions when said elastomer is cyclically worked in an operation environmental temperature of at least 190° F.

46. A method of making a machine component, said method including:
providing a first nonelastomeric machine component member,
bonding a >190° F. heat spring rate fatigue resistant elastomer to said first nonelastomeric machine component member with said >190° F. heat spring rate fatigue resistant elastomer including a plurality of dispersed nonelastomeric nanosheets to provide an at least 190° F. heat resistant machine component.

47. A method of making a vehicle, said method including:
providing a vehicle having an operational environment temperature of at least 190 degrees Fahrenheit,
providing a machine component, said machine component including an elastomer having a plurality of dispersed nonelastomeric nanosheets,
installing said machine component in said vehicle wherein said elastomer is heated to at least 190 degrees Fahrenheit in said operational environment temperature of at least 190 degrees Fahrenheit.

48. A method as claimed in claim 47 wherein installing includes installing said machine component with an operational position wherein a tension load in said elastomer is inhibited.

49. A machine component, said machine component including an intermediate elastomeric body, said intermediate elastomeric body providing an acceptable machine component spring rate performance operational lifetime, said intermediate elastomeric body comprised of a elastomer having an elastomer composition, said elastomer including a plurality of dispersed nonelastomeric nanosheets, said dispersed nonelastomeric nanosheets having a first planar dimension greater than 25 nm, a second planar dimension greater than 25 nm, and a thickness dimension less than 2 nm, wherein said intermediate elastomeric body has an increased acceptable machine component spring rate performance operational lifetime above 190° F. relative to said elastomer composition absent said dispersed nonelastomeric nanosheets.

50. A machine component, said machine component including an intermediate elastomeric body, said intermediate elastomeric body providing an acceptable machine component spring rate performance operational lifetime, said intermediate elastomeric body comprised of a elastomer having an elastomer composition, said elastomer including a means for increasing said acceptable machine component spring rate performance operational lifetime in an above 190° F. operation temperature environment.

51. A machine component, said machine component including an intermediate elastomeric body, said intermediate elastomeric body providing an acceptable machine component elastomer structural integrity operational lifetime, said intermediate elastomeric body comprised of a elastomer having an elastomer composition, said elastomer including a plurality of dispersed nonelastomeric nanosheets, said dispersed nonelastomeric nanosheets having a first planar dimension greater than 25 nm, a second planar dimension greater than 25 nm, and a thickness dimension less than 2 nm, wherein said intermediate elastomeric body has an increased acceptable machine component operational lifetime above 190° F. relative to said elastomer composition absent said dispersed nonelastomeric nanosheets.

52. A machine component, said machine component including an intermediate elastomeric body, said intermediate elastomeric body providing an acceptable machine component elastomer structural integrity operational lifetime, said intermediate elastomeric body comprised of a elastomer having an elastomer composition, said elastomer including a means for increasing said acceptable machine component operational lifetime in an above 190° F. operation temperature environment.

53. An engine mount, said engine mount including an at least a first nonelastomeric engine mount member and an at least a second nonelastomeric mount member, and an intermediate elastomeric body bonded between said first nonelastomeric engine mount member and said second nonelastomeric mount member, said intermediate elastomeric body comprised of a >210° F. heat resistant elastomer having a plurality of dispersed nonelastomeric nanosheets with a first planar dimension greater than 25 nm, a second planar dimension greater than 25 nm, and a thickness dimension less than 2 nm.

54. A rubber to metal device for connecting a high temperature operating heat source to a body structure, said high temperature operating heat source having a heat source operation environment temperature of at least 190 degrees Fahrenheit, said rubber to metal device including:
an at least a first metal member for attachment to said high temperature operating heat source,
an at least a second metal member for attachment to said body structure,
an intermediate rubber, said intermediate rubber disposed between said
first metal member and said second metal member,
said rubber to metal device having an operational lifetime beginning spring rate SR_{BZ} and an operational lifetime end spring rate SR_{E} with SR_{E}=0.8 SR_{BZ}, with an operational lifetime OL measured by a plurality of operational deflection cycles between said first metal member and said second metal member until said operational lifetime end spring rate SR_{E} is reached, wherein said rubber to metal device has an increased operational lifetime OL at said heat source operation environment temperature of at least 190 degrees Fahrenheit with said intermediate rubber including a plurality of dispersed nonelastomeric nanosheets having a aspect ratio of at least 5 to 1.

55. A rubber to metal device as claimed in claim 54 wherein said increased operational lifetime OL is at least ten percent greater than an operational lifetime of a second comparison rubber to metal device with said intermediate rubber absent said plurality of dispersed nonelastomeric nanosheets.

56. A rubber to metal device as claimed in claim 54 wherein said rubber to metal device has said increased operational lifetime OL with said heat source operation environment temperature at least 202 degrees Fahrenheit.

57. A rubber to metal device as claimed in claim 54 wherein said rubber to metal device has said increased operational lifetime OL with said heat source operation environment temperature at least 238 degrees Fahrenheit.

58. A rubber to metal device as claimed in claim 54 wherein said rubber includes a predetermined amount of said dispersed nonelastomeric nanosheets to provide said rubber to metal device with a substantial increase in said operational lifetime OL.

59. A rubber to metal device as claimed in claim 54 wherein said increased operational lifetime OL is at least fifteen percent greater than an operational lifetime of a second comparison rubber to metal device with said intermediate rubber absent said plurality of dispersed nonelastomeric nanosheets.

60. A rubber to metal device as claimed in claim 54 wherein said operational deflection cycles compress said intermediate rubber.

61. A rubber to metal device as claimed in claim 54 wherein said operational deflection cycles shear said intermediate rubber.

62. A rubber to metal device as claimed in claim 54 wherein said operational deflection cycles compress and shear said intermediate rubber.

63. A rubber to metal device as claimed in claim 54 wherein said rubber to metal device has a spring rate growth peak during said operational lifetime, with said spring rate growth peak at least one percent above said beginning spring rate SR_{BZ}.

64. A rubber to metal device as claimed in claim 54 wherein said rubber to metal device contains a fluid.

65. A rubber to metal device as claimed in claim 54 wherein said operational lifetime OL is at least one and half million cycles.

66. A rubber to metal device as claimed in claim 54 wherein said high temperature operating heat source is an internal combustion heat source.

67. A rubber to metal device as claimed in claim 54 wherein said body structure is a vehicle body structure.

68. A rubber to metal device as claimed in claim 54 wherein said dispersed nonelastomeric nanosheets have at least a first dimension greater than 25 nm and at least one thickness dimension less than 25 nm.

69. A method of making a rubber to metal device, said method including:
providing a first metal member,
providing a second nonelastomeric body member,
disposing a heat resistant intermediate rubber between said first metal member and said second body member with said
said heat resistant intermediate rubber including a plurality of dispersed nonelastomeric nanosheets.

70. A method of making a rubber to metal device as claimed in claim 69 wherein an operational deflection between said first metal member and said second body member compresses said heat resistant intermediate rubber.

71. A method of making a rubber to metal device as claimed in claim 69 wherein an operational deflection between said first metal member and said second body member shears said heat resistant intermediate rubber.

72. A method of making a rubber to metal device as claimed in claim 69 wherein said heat resistant intermediate rubber is comprised of a rubber composition with said nonelastomeric nanosheets dispersed within said rubber composition.

73. A method of making a rubber to metal device as claimed in claim 72, includes mixing a nanosheet masterbatch with said rubber composition.

74. A method of making a rubber to metal device as claimed in claim 69 wherein said intermediate rubber provides an operational lifetime beginning spring rate SR_{BZ} and an operational lifetime end spring rate SR_{E} with SR_{E}=0.8 SR_{BZ}, with an operational lifetime OL measured by a plurality of operational deflection cycles between said first nonelastomeric member and said second nonelastomeric member until said operational lifetime end spring rate SR_{E} is reached, wherein said rubber to metal device has an increased operational lifetime OL at an heat source operation environment temperature of at least 190 degrees Fahrenheit.

75. A method as claimed in claim 74 wherein said increased operational lifetime OL is at least ten percent greater than an operational lifetime of a second comparison rubber to metal device with said intermediate rubber absent said plurality of dispersed nonelastomeric nanosheets.

76. A method as claimed in claim 74 wherein said increased operational lifetime OL is at least one and half million cycles.

77. A method of making a rubber to metal device as claimed in claim 69 wherein said intermediate rubber provides an operational lifetime OL measured by a plurality of operational deflection cycles between a first deflection cycle and a rubber mount failure lifetime end cycle with the operational deflection cycles between said first nonelastomeric member and said second nonelastomeric member, wherein said rubber to metal device has an increased operational lifetime OL at an heat source operation environment temperature of at least 190 degrees Fahrenheit.

78. A method of making a rubber to metal device as claimed in claim 69 wherein said method include providing a mount fluid and containing said mount fluid in said rubber to metal device with said intermediate rubber.

79. A method of making a rubber to metal device as claimed in claim 69 wherein said first metal member is provided for connection proximate a high temperature operating internal combustion heat source.

80. A method of making a rubber to metal device as claimed in claim 69 wherein said second nonelastomeric body member is provided for connection proximate a vehicle body structure.
